(19) United States
(12) Patent Application Publication
(10) Pub. No.: US 2021/0016265 A1
(43) Pub. Date: Jan. 21, 2021

(54) Mixed Catalyst System

(71) Applicant: ExxonMobil Chemical Patents Inc., Baytown, TX (US)

(72) Inventors: Matthew W. Holtcamp, Huffman, TX (US); Crisita Carmen H. Atienza, Houston, TX (US); David A. Cano, Houston, TX (US); Matthew S. Bedoya, Humble, TX (US)

(21) Appl. No.: 16/910,015

(22) Filed: Jun. 23, 2020

Related U.S. Application Data
(60) Provisional application No. 62/875,738, filed on Jul. 18, 2019.

(51) Int. Cl. B01J 31/18; B01J 31/22; C08F 4/64; C08F 4/642; C08F 4/60; C08F 4/659

(52) U.S. Cl. CPC B01J 31/1815; B01J 31/2217; C08F 4/64158; C08F 2/34; C08F 4/60113; C08F 4/65908; C08F 4/65916; C08F 4/6428

(57) ABSTRACT

This invention relates to a supported catalyst system comprising a first iron based catalyst, a second group 4 metal catalyst, a support material, and an activator; wherein the first catalyst is represented by Formula (I) and the second catalyst is represented by Formula (II):

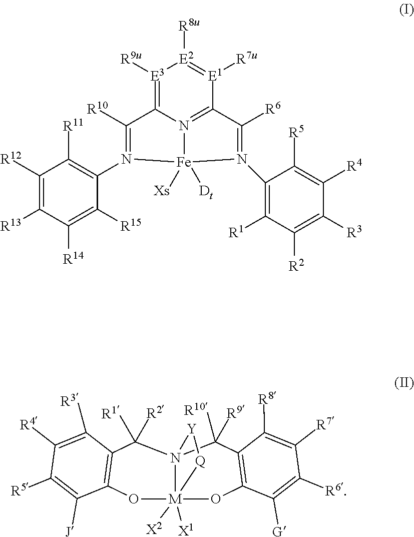

### CROSS-REFERENCE TO RELATED APPLICATIONS

This application claims the priority benefit of Provisional Application No. 62/875,738, filed Jul. 18, 2019, the disclosure of which is incorporated herein by reference.

### FIELD

This invention relates to supported catalyst systems and processes for using same. More particularly, the supported catalyst systems can include an ONYO type compound, an iron compound, a support material, and, optionally, an activator. The catalyst system can be used for olefin polymerization processes.

### BACKGROUND

Olefin polymerization catalysts are of great use in industry. Hence, there is interest in finding new catalyst systems that increase the production of polymers and/or the production of polymers having improved properties. Catalysts for olefin polymerization are often based on metallocene catalyst systems having cyclopentadienyl transition metal compounds as catalyst precursors combined with activators, typically an alumoxane and/or with an activator containing a non-coordinating anion.

A typical metallocene catalyst system includes a metallocene catalyst, an activator, and optional support. Supported catalyst systems are used in many polymerization processes, often in slurry or gas phase polymerization processes.

There is a need for new and improved catalyst systems for the polymerization of olefins that have an increased activity and/or enhance polymer properties, such as an increased melting point, a greater density, an increased molecular weight, an increased comonomer incorporation, and/or an altered comonomer distribution. There is also a need for ethylene polymers having a broad orthogonal composition distribution.

Additional references of interest may include: U.S. Pat. Nos. 4,701,432; 5,077,255; 7,141,632; 6,207,606; 8,598,061; Hong, S. C. et al. (2007) “Immobilized Me₂Si(C₅Me₄)(N-tBu)TiCl₂/(nBuCp)₂ZrCl₂ Hybrid Metallocene Catalyst System for the Production of Poly(ethylene-co-hexene) with Pseudo-bimodal Molecular Weight and Inverse Comonomer Distribution,” Polymer Engineering and Science, v.47(2), pages 131-139; US 2012/0130032; U.S. Pat. Nos. 7,192,902; 8,110,518; 7,355,058; 5,382,630; 5,382,631; 8,575,284, 6,069,213; Kim, J. D. et al. (2000) “Copolymerization of Ethylene and α-Olefins with Combined Metallocene Catalysts. III. Production of Polyolefins with Controlled Microstructures,” J. Polym. Sci. Part A: Polym Chem., v.38(9), pp. 1427-1432; Iedema, P. D. et al. (2004) “Predicting the Molecular Weight Distribution of Polyethylene for Mixed Systems with a Constrained-Geometry Metallocene Catalysts in a Semibatch Reactor,” Ind. Eng. Chem. Res., v.43(1), pp. 36-50; U.S. Pat. Nos. 6,656,866; 8,815,357; US 2004/259722; US 2014/0031504; U.S. Pat. Nos. 5,135,526; 7,385,015; WO 2007/080365; WO 2012/006272; WO 2014/242314; WO 2000/012565; WO 2002/060957; WO 2004/046214; WO 2009/146167; EP 2374822A1; PCT/US2016/021757, filed Mar. 10, 2016; WO 2012/158260; U.S. Pat. Nos. 8,378,029; 7,855,253; 7,595,364; US 2006/275571; EP 2003166A1; WO 2007/067259; US 2014/0127427; U.S. Pat. Nos. 7,619,047; 8,138,113; US 2016/0032027; Sheu, S. (2006), “Enhanced Bimodal PE Makes the Impossible Possible”, https://docplayer.net/39888384-Enhanced-bimodal-pe-makes-the-impossible-possible.html; Chen, K. et al. (2014) “Modeling and Simulation of Borstar Bimodal Polyethylene Process Based on Rigorous PC-SAFT Equation of State Model,” Industrial & Engineering Chem. Res., v.53, pp. 19905-19915; U.S. Pat. Nos. 5,032,562; 5,525,678; and EP 0729387; U.S. Pat. Nos. 7,199,072; 7,172,987; 7,129,302; 6,964,937; 6,956,094; and 6,828,394; 6,995,109; EP 0676418; WO 1998/049209; WO 1997/035891; and U.S. Pat. No. 5,183,867.

### SUMMARY

This invention relates to a supported catalyst system and process for use thereof, said system comprising a first catalyst, a second catalyst, a support material, and an activator; wherein the first catalyst is represented by the Formula (I):

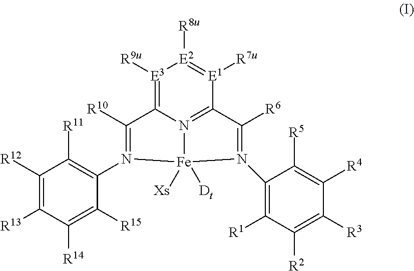

where R¹, R⁵, R¹¹, and R¹⁵ are independently C₁-C₄₀ hydrocarbyl, C₁-C₄₀ substituted hydrocarbyl group, heteroatom or heteroatom-containing group,

R⁷ᵤ, R⁸ᵤ, R⁹ᵤ, R², R³, R⁴, R⁶, R¹⁰, R¹², R¹³, and R¹⁴ are independently hydrogen, C₁-C₄₀ hydrocarbyl, C₁-C₄₀ substituted hydrocarbyl group, heteroatom or heteroatom-containing group, wherein two or more of R⁷ᵤ, R⁸ᵤ, R⁹ᵤ, R¹, R², R³, R⁴, R⁵, R⁶, R¹⁰, R¹¹, R¹², R¹³, R¹⁴, and R¹⁵, may independently join together to form a C₄ to C₆₂ cyclic or polycyclic ring structure;

E¹, E², and E³ are independently C, N, or P;

each u is independently 0 if E¹, E², and/or E³ is N or P and is 1 if E¹, E², and/or E³ is C;

X is hydrogen, C₁-C₄₀ hydrocarbyl, C₁-C₄₀ substituted hydrocarbyl group, heteroatom or heteroatom-containing group;

s is 1, 2, or 3;

D is a neutral donor; and

t is 0, 1, or 2; and

wherein the second catalyst is represented by the Formula (II):

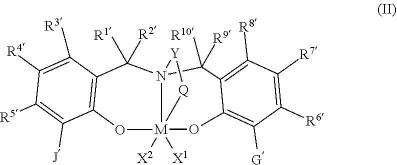

wherein:

M is a group 4 transition metal;

X¹ and X² are independently C₁-C₄₀ hydrocarbyl, C₁-C₄₀ substituted hydrocarbyl, heteroatom or heteroatom-containing group, wherein X¹ optionally bonds with X² to form a C₄ to C₆₂ cyclic or polycyclic ring structure;

R^{1′}, R^{2′}, R^{3′}, R^{4′}, R^{5′}, R^{6′}, R⁷, R^{8′}, R^{9′}, and R^{10′} are independently hydrogen, C₁-C₄₀ hydrocarbyl, C₁-C₄₀ substituted hydrocarbyl group, heteroatom or heteroatom-containing group, where two or more of R^{1′} to R^{10′}, J′ and G′ may independently join together to form a C₄ to C₆₂ cyclic or polycyclic ring structure;

J′ is a C₇ to C₆₀ fused polycyclic group, which optionally includes up to 20 atoms from groups 15 and 16, wherein at least one ring can be aromatic and wherein at least one ring, which may or may not be aromatic, has at least five members;

G′ is hydrogen, C₁ to C₆₀ hydrocarbyl, C₁-C₆₀ substituted hydrocarbyl group, a heteroatom or heteroatom-containing group or optionally as defined for J′;

Y is hydrogen, C₁-C₄₀ hydrocarbyl, C₁-C₄₀ substituted hydrocarbyl group, heteroatom or heteroatom-containing group; and

Q is a neutral donor group.

### BRIEF DESCRIPTION OF THE DRAWINGS

So that the manner in which the above recited features of the present invention can be understood in detail, a more particular description of the invention, briefly summarized above, can be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a graph of molecular weight versus the amount of comonomer content of the polymer produced from catalyst 1 in Example 1.

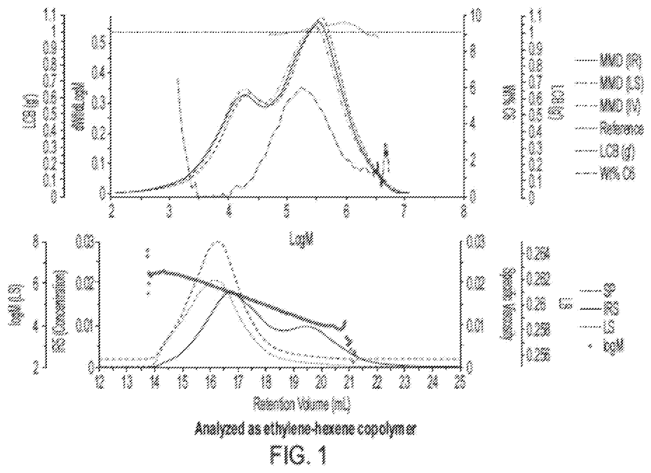

FIG. 2 depicts a graph of molecular weight versus the amount of comonomer content of the polymer produced from catalyst 2 in Example 1.

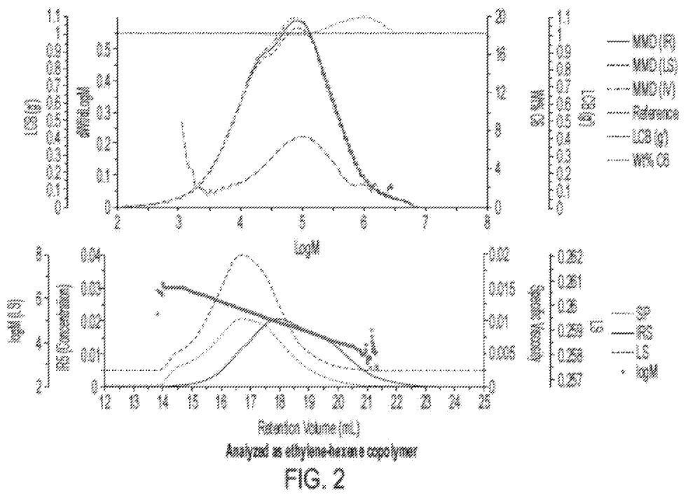

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

### Definitions

The term “catalyst system”, as used herein, refers to a combination of at least two catalyst compounds, optional activator, and a support material. The catalyst system can also include one or more additional catalyst compounds. The terms “mixed catalyst system”, “dual catalyst system”, “mixed catalyst”, and “supported catalyst system” can be used interchangeably herein with “catalyst system.” For the purposes of this disclosure and the claims thereto, when catalyst systems are described as including neutral stable forms of the components, it is well understood by one of ordinary skill in the art, that the ionic form of the component is the form that reacts with the monomers to produce polymers.

The term “complex” is used to describe molecules in which an ancillary ligand is coordinated to a central transition metal atom. The ligand is bulky and stably bonded to the transition metal so as to maintain its influence during use of the catalyst, such as polymerization. The ligand can be coordinated to the transition metal by covalent bond and/or electron donation coordination or intermediate bonds. The transition metal complexes are generally subjected to activation to perform their polymerization function using an activator which is believed to create a cation as a result of the removal of an anionic group, often referred to as a leaving group, from the transition metal. The term “complex” is also often referred to as “catalyst precursor”, “pre-catalyst”, “catalyst”, “catalyst compound”, “metal compound”, “transition metal compound”, or “transition metal complex” and these words are used interchangeably. “Activator” and “cocatalyst” are also used interchangeably.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

Unless otherwise indicated, (e.g., the definition of “substituted hydrocarbyl”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, or a hydrocarbyl or halocarbyl radical (such as H or a C₁ to C₂₀ hydrocarbyl group), and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently H, a hydrocarbyl or halocarbyl radical (such as H or a C₁ to C₂₀ hydrocarbyl group), and two or more R* may join together to form a substituted or unsubstituted completely saturated, partially unsaturated, or aromatic cyclic or polycyclic ring structure), or where at least one heteroatom has been inserted within a hydrocarbyl ring.

The term “ring atom” means an atom that is part of a cyclic ring structure. By this definition, a benzyl group has six ring atoms and tetrahydrofuran has 5 ring atoms.

A “ring carbon atom” is a carbon atom that is part of a cyclic ring structure. By this definition, a benzyl group has six ring carbon atoms and para-methylstyrene also has six ring carbon atoms.

The terms “aryl” and “aryl group” mean a six carbon aromatic ring, including but not limited to, phenyl, 2-methyl-phenyl, xylyl, 4-bromo-xylyl. Likewise, heteroaryl means an aryl group where a ring carbon atom (or two or three ring carbon atoms) is/are replaced with a heteroatom, preferably, N, O, or S.

A “heterocyclic ring” is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

As used herein, the numbering scheme for the Periodic Table groups is the notation as set out in Chemical and Engineering News, v.63(5), 27, (1985).

An “olefin”, is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. “Different” as used to refer to mer units indicates that the mer units differ from each other by at least one atom or are different isomerically. Accordingly, the definition of copolymer, as used herein, includes terpolymers and the like. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

An ethylene polymer having a density of 0.86 g/cm³ or less is referred to as an ethylene elastomer or elastomer; an ethylene polymer having a density of more than 0.86 to less than 0.910 g/cm³ is referred to as an ethylene plastomer or plastomer; an ethylene polymer having a density of 0.910 to 0.940 g/cm³ is referred to as a low density polyethylene; and an ethylene polymer having a density of more than 0.940 g/cm³ is referred to as a high density polyethylene (HDPE). Density is determined according to ASTM D 1505 using a density-gradient column on a compression-molded specimen that has been slowly cooled to room temperature (i.e., over a period of 10 minutes or more) and allowed to age for a sufficient time that the density is constant within +/−0.001 g/cm³).

Polyethylene in an overlapping density range, i.e., 0.890 to 0.930 g/cm³, typically from 0.915 to 0.930 g/cm³, which is linear and does not contain long chain branching is referred to as “linear low density polyethylene” (LLDPE) and can be produced with conventional Ziegler-Natta catalysts, vanadium catalysts, or with metallocene catalysts in gas phase reactors and/or in slurry reactors and/or in solution reactors. “Linear” means that the polyethylene has no long chain branches, typically referred to as a branching index (g′ᵥᵢₛ) of 0.97 or above, preferably 0.98 or above. Branching index, g′ᵥᵢₛ, is measured as described below.

For the purposes of this disclosure, ethylene shall be considered an α-olefin.

As used herein, Mₙ is number average molecular weight, M_{w} is weight average molecular weight, and M_{z} is z average molecular weight, wt % is weight percent, and mol % is mole percent. Molecular weight distribution (MWD), also referred to as polydispersity index (PDI), is defined to be M_{w} divided by Mₙ. Unless otherwise noted, all molecular weights (e.g., M_{w}, Mₙ, M_{z}) are reported in units of g/mol. The following abbreviations can be used herein: Me is methyl, Et is ethyl, t-Bu and ^{t}Bu are tertiary butyl, iPr and ⁱPr are isopropyl, Cy is cyclohexyl, THF (also referred to as thf) is tetrahydrofuran, Bn is benzyl, Ph is phenyl, Cp is cyclopentadienyl, Cp* is pentamethyl cyclopentadienyl, Ind is indenyl, Flu is fluorenyl, and MAO is methylalumoxane.

As used herein, the term “C” means hydrocarbon(s) having n carbon atom(s) per molecule, where n is a positive integer. Likewise, a “Cₘ-C_{y}” group or compound refers to a group or compound including carbon atoms at a total number thereof in the range from m to y. Thus, a C₁-C₄ alkyl group refers to an alkyl group that includes carbon atoms at a total number thereof in the range of 1 to 4, e.g., 1, 2, 3 and 4.

As used herein, the term “neutral donor” means any heteroatom containing Lewis base, such as amines, ethers, phoshines or sulfides. In some examples, the neutral donor can be cyclic. In some examples, the neutral donor can be trimethylamine, pyridine, diethyl ether, tetrahydrofuran, or dimethyl sulfide.

A supported catalyst system can include a first catalyst, a second catalyst, a support material, and an activator, where the first catalyst comprises an iron catalyst and the second catalyst comprises an ONYO type catalyst.

It has been surprisingly and unexpectedly discovered that using a catalyst system that includes an iron catalyst and an ONYO type catalyst can produce an ethylene copolymer having a broad orthogonal composition distribution and having a higher molecular weight than a broad orthogonal composition distribution ethylene copolymer produced from a metallocene catalyst system.

Broad orthogonal composition distribution means the comonomer is incorporated predominantly in the high molecular weight chains. The distribution of the short chain branches can be measured, for example, using Temperature Raising Elution Fractionation (TREF) in connection with a Light Scattering (LS) detector to determine the weight average molecular weight of the molecules eluted from the TREF column at a given temperature. The combination of TREF and LS (TREF-LS) yields information about the breadth of the composition distribution and whether the comonomer content increases, decreases, or is uniform across the chains of different molecular weights.

Certain advantages of a broad orthogonal composition distribution (BOCD) for improved physical properties and low extractables content are disclosed in, for example, U.S. Pat. No. 5,382,630.

The TREF-LS data is measured using an analytical size TREF instrument (Polymerchar, Spain), with a column of the following dimension: inner diameter (ID) 7.8 mm and outer diameter (OD) 9.53 mm and a column length of 150 mm. The column is filled with steel beads. 0.5 mL of a 6.4% (w/v) polymer solution in orthodichlorobenzene (ODCB) containing 6 g BHT/4 L is charged onto the column and cooled from 140° C. to 25° C. at a constant cooling rate of 1.0° C./min. Subsequently, ODCB is pumped through the column at a flow rate of 1.0 ml/min, and the column temperature increased at a constant heating rate of 2° C./min to elute the polymer. The polymer concentration in the eluted liquid is detected by means of measuring the absorption at a wavenumber of 2,857 cm¹ using an infrared detector. The concentration of the ethylene-α-olefin copolymer in the eluted liquid is calculated from the absorption and plotted as a function of temperature. The molecular weight of the ethylene-α-olefin copolymer in the eluted liquid is measured by light scattering using a Minidawn Tristar light scattering detector (Wyatt, Calif., USA). The molecular weight is plotted as a function of temperature.

The breadth of the composition distribution can be characterized by the T₇₅-T₂₅ value, wherein T₂₅ is the temperature at which 25% of the eluted polymer is obtained and T₇₅ is the temperature at which 75% of the eluted polymer as determined by TREF-LS, as described herein. The composition distribution can be further characterized by the F₈₀ value, which is the fraction of polymer molecules that elute below 80° C. as determined by TREF-LS, as described herein. A higher F₈₀ value indicates a higher fraction of comonomer, in the polymer molecule. An orthogonal composition distribution is defined by a M₆₀/M₉₀ value that is greater than 1, where M₆₀ is the molecular weight of the polymer fraction that elutes at 60° C. and M₉ is the molecular weight of the polymer fraction that elutes at 90° C. as determined by TREF-LS, as described herein.

The above two catalyst components can have different hydrogen responses (each having a different reactivity toward hydrogen) during the polymerization process. Hydrogen is often used in olefin polymerization to control the final properties of the polyolefin. The ONYO catalyst component can show a larger response to changes of hydrogen concentration in the reactor than the iron catalyst component. Owing to the differing hydrogen response of the catalyst components in the supported catalyst system, the properties of the resulting polymer are controllable. Changes of hydrogen concentration in the reactor can affect the molecular weight, the molecular weight distribution, and other properties of the resulting polyolefin when using a combination of such two catalyst components. Thus, the supported catalyst system using an iron catalyst and an ONYO type catalyst can produce a multi-modal polyolefin.

### Iron Catalyst

The first catalyst comprises an iron catalyst represented by the chemical Formula (I):

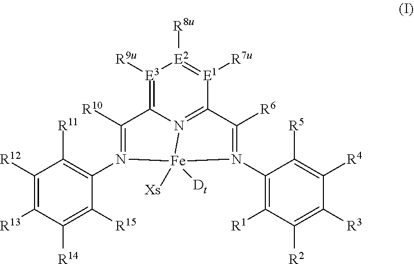

where R¹, R⁵, R¹¹, and R¹⁵ are independently C₁-C₄₀ hydrocarbyl, C₁-C₄₀ substituted hydrocarbyl group, a heteroatom, or heteroatom-containing group, wherein R⁷ᵤ, R⁸ᵤ, R⁹ᵤ, R², R³, R⁴, R⁶, R¹⁰, R¹², R¹³, R¹⁴, and X are independently hydrogen, C₁-C₄₀ hydrocarbyl, C₁-C₄₀ substituted hydrocarbyl group, a heteroatom, or heteroatom-containing group, where two or more of R⁷ᵤ, R⁸ᵤ, R⁹ᵤ, R¹, R², R³, R⁴, R⁵, R⁶, R¹⁰, R¹¹, R¹², R¹³, R¹⁴, and R¹⁵ may independently join together to form a C₄ to C₆₂ cyclic or polycyclic ring structure (for example, R¹ optionally bonds with R², R² optionally bonds with R³, R³ optionally bonds with R⁴, R⁴ optionally bonds with R⁵, R⁵ optionally bonds with R⁶, R⁶ optionally bonds with R⁷, R⁷ optionally bonds with R⁸, R⁸ optionally bonds with R⁹, R⁹ optionally bonds with R¹⁰, and R¹⁰ optionally bonds with R¹¹, R¹¹ optionally bonds with R¹², R¹² optionally bonds with R¹³, R¹³ optionally bonds with R¹⁴, and R¹⁴ optionally bonds with R¹⁵, in each case to independently form a five-, six- or seven-membered ring); E¹, E², and E³ are independently C, N, or P; each u is independently 0 if E¹, E², and/or E³ is N or P and is 1 if E¹, E², and/or E³ is C; s is 1, 2, or 3; D is a neutral donor; and t is 0, 1, or 2.

In some examples, each of R¹¹ and R⁵ can be chlorine; each of R⁶ and R¹⁰ can be methyl; each of R⁷, R⁸, and R⁹ can be hydrogen; each of R¹³ and R¹⁵ can be methyl; each of R², R⁴, R¹², R¹³, and R¹⁴ can be independently hydrogen, C₁-C₂₀ hydrocarbyl, or C₁-C₂₀ substituted hydrocarbyl group; and/or each of E¹, E², and E³ can be carbon; and each u is 1.

In some examples, each of R¹¹ and R⁵ is chlorine; each of R⁶ and R¹⁰ is methyl; each of R⁷, R⁸, and R⁹ is hydrogen; each of R¹³ and R¹⁵ is methyl; each of R², R⁴, R¹², R¹³, and R¹⁴ is independently hydrogen, C₁-C₂₀ hydrocarbyl, or C₁-C₂₀ substituted hydrocarbyl group; and each of E¹, E², and E³ is carbon; and each u is 1.

In some examples, each of R¹¹ and R⁵ is chlorine. In some examples, each of R⁶ and R¹⁰ is methyl. In some examples, each of R⁷, R⁸, and R⁹ is hydrogen. In some examples, each of R¹³ and R¹⁵ is methyl. In some examples, each of R², R⁴, R¹², R¹³, and R¹⁴ is independently hydrogen, C₁-C₂₀ hydrocarbyl, or C₁-C₂₀ substituted hydrocarbyl group. In some examples, each of E¹, E², and E³ is carbon and each u is 1.

In some examples, the first catalyst is one or more of:
bis(2,6-[1-(2,6-dimethylphenylimino)ethyl])pyridineiron dichloride,
bis(2,6-[1-(2,4,6-trimethylphenylimino)ethyl)])pyridineiron dichloride,
bis(2,6-[1-(2,6-dimethylphenylimino)ethyl]-ethyl])pyridineiron dichloride,
2-[1-(2,4,6-trimethylphenylimino)ethyl]-6-[1-(2,4-dichloro-6-methylphenylimino)ethyl]pyridineiron dichloride,
2-[1-(2,6-dimethylphenylimino)ethyl]-6-[1-(2-chloro-6-methylphenylimino)ethyl]pyridineiron dichloride,
2-[1-(2,4,6-trimethylphenylimino)ethyl]-6-[1-(2-chloro-6-methylphenylimino)ethyl]pyridineiron dichloride,
2-[1-(2,6-diisopropylphenylimino)ethyl]-6-[1-(2-chloro-6-methylphenylimino)ethyl]pyridineiron dichloride,
2-[1-(2,6-dimethylphenylimino)ethyl]-6-[1-(2-bromo-4,6-dimethylphenylimino)ethyl]pyridineiron dichloride,
2-[1-(2,4,6-trimethylphenylimino)ethyl]-6-[1-(2-bromo-4,6-dimethylphenylimino)ethyl]pyridineiron dichloride,
2-[1-(2,6-dimethylphenylimino)ethyl]-6-[1-(2-bromo-6-methylphenylimino)ethyl]pyridineiron dichloride,
2-[-(2,4,6-trimethylphenylimino)ethyl]-6-[1-(2-bromo-6-methylphenylimino)ethyl]pyridineiron dichloride, and
2-[1-(2,6-diisopropylphenylimino)ethyl]-6-[-(2-bromo-6-methylphenylimino)ethyl]pyridineiron dichloride, or the dibromides or tribromides thereof (e.g., where dichloride in the list above can be replaced with dibromide or tribromide).

### ONYO-Type Catalyst

In some examples, the second catalyst comprises an ONYO type catalyst represented by the following chemical Formula (II):

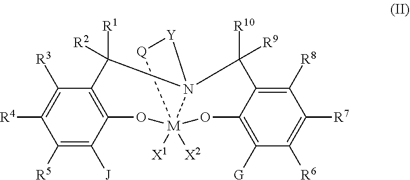

where M is a group 4 transition metal (such as Zr, Hf or Ti); X¹ and X² are independently C₁-C₄₀ (optionally C₁ to C₂₀) hydrocarbyl, C₁-C₄₀ (optionally C₁ to C₂₀) substituted hydrocarbyl group, a first heteroatom or heteroatom-containing group, wherein X¹ optionally bonds with X² to form a C₄-C₆₂ cyclic or polycyclic ring structure; R¹, R², R³, R⁴, R⁵, R⁶, R⁷, R₈^{u}, R⁹, and R¹⁰ are independently H, C₁-C₄₀ (optionally C₁ to C₂₀) hydrocarbyl, C₁-C₄₀ (optionally C₁ to C₂₀) substituted hydrocarbyl group, a second heteroatom or heteroatom-containing group, where two or more of R¹ to R¹⁰, J and G may independently join together to form a C₄ to C₆₂ (optionally C₅ to C₁₄, optionally C₅, C₆ or C₇) cyclic or polycyclic ring structure (for example, R¹ optionally bonds with R², and R² optionally bonds with R³, R³ optionally bonds with R⁴, R⁴ optionally bonds with R⁵, R⁵ optionally bonds with J, G optionally bonds with R⁶, R⁶ optionally bonds with R⁷, R⁷ optionally bonds with R⁸, R⁸ optionally bonds with R⁹, R⁹ optionally bonds with R¹⁰ in each case to independently form a five-, six- or seven-membered ring); Q is a neutral donor group; J is a C₇ to C₆₀ fused polycyclic group, which optionally includes up to 20 atoms from groups 15 and 16, wherein at least one ring can be aromatic and wherein at least one ring, which may or may not be aromatic, has at least five members; G is hydrogen, C₁ to C₆₀ hydrocarbyl, C₁-C₆₀ substituted hydrocarbyl group, a heteroatom or heteroatom-containing group; and Y is a divalent C₁ to C₄₀ hydrocarbyl or is a divalent substituted C₁ to C₄₀ hydrocarbyl.

In some examples, the second catalyst can be an ONYO type catalyst represented by the following chemical Formula (III) or (IV):

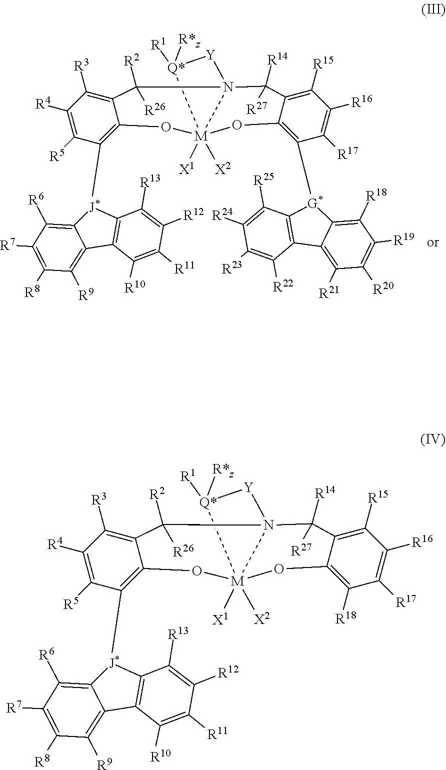

where: M, X¹, X², R¹, R², R³, R⁴, R⁵, R⁶, R⁷, R₈^{u}, R⁹, R¹⁰, and Y are as defined above; Q* is a group 15 or 16 atom such as N, O, S, or P); z is 0 or 1; J* is CR″ or N; and G* is CR″ or N; each R″, R*, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, and R²⁷ is independently a hydrogen, a C₁ to C₄₀ hydrocarbyl radical, a C₁ to C₄₀ substituted hydrocarbyl radical, a heteroatom or a heteroatom-containing group, or two or more of R″, R*, R¹ to R²⁷ may independently join together to form a C₄ to C₆₂ cyclic or polycyclic ring structure (such as a five-, six- or seven-membered ring).

In any embodiment of the transition metal complexes of Formula (II), (III), or (IV) described herein M may be Hf, Ti, or Zr, preferably Hf or Zr.

In any embodiment of the transition metal complexes of Formula (II), (III), or (IV) described herein, each of X¹ and X² is independently selected from the group consisting of optionally substituted hydrocarbyl radicals having from 1 to 40 carbon atoms (such as methyl, ethyl, ethenyl, and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and eicosyl), hydrides, amides, alkoxides having from 1 to 20 carbon atoms, sulfides, phosphides, halides, sulfoxides, sulfonates, phosphonates, nitrates, carboxylates, carbonates, and combinations thereof, preferably each of X¹ and X² is independently selected from the group consisting of halides (F, Cl, Br, I), alkyl radicals having from 1 to 7 carbon atoms (methyl, ethyl, propyl, butyl, pentyl, hexyl, heptyl, and isomers thereof), benzyl radicals, or a combination thereof.

In any embodiment of the transition metal complexes of Formula (II), (III), or (IV) described herein, Y is a divalent C₁ to C₄₀ hydrocarbyl radical or divalent substituted hydrocarbyl radical comprising a portion that comprises a linker backbone comprising from 1 to 18 carbon atoms linking or bridging between Q and N. In an embodiment, Y is a divalent C₁ to C₄₀ hydrocarbyl or substituted hydrocarbyl radical comprising a portion that comprises a linker backbone comprising from 1 to 18 carbon atoms linking Q and N wherein the hydrocarbyl comprises 0, S, S(O), S(O)₂, Si(R′)₂, P(R′), N, or N(R′), wherein each R′ is independently a C₁ to C₁₈ hydrocarbyl.

In some examples, Y is ethylene (—CH₂CH₂—) or 1,2-cyclohexylene. In some examples, Y is propylene(˜CH₂CH₂CH₂—). In some examples, Y is a divalent C₁ to C₂₀ alkyl group, such as divalent methyl, ethyl, ethenyl and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and eicosyl.

In some examples, R¹, R², R³, R⁴, R⁵, R⁶, R⁷, R⁸, R⁹, and R¹⁰ are independently a hydrogen, a C₁ to C₂₀ hydrocarbyl, a substituted C₁ to C₂₀ hydrocarbyl, or two or more of R¹ to R¹⁰ can independently join together to form a C₄ to C₆₂ cyclic or polycyclic ring structure, or a combination thereof.

In some examples, R*, R″, R¹, R², R³, R⁴, R⁵, R⁶, R⁷, R₈^{u}, R⁹, R¹⁰, R¹¹, R¹², R¹³, R¹⁴, R¹⁵, R¹⁶, R¹⁷, R¹⁸, R¹⁹, R²⁰, R²¹, R²², R²³R²⁴, R²⁵, R²⁶, and R²⁷ can independently be hydrogen, a halogen, a C₁ to C₃₀ hydrocarbyl, a C₁ to C₂₀ hydrocarbyl, or a C₁ to C₁₀ hydrocarbyl (such as methyl, ethyl, ethenyl and isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, and eicosyl).

In some examples, R*, R″, R¹, R², R³, R⁴, R⁵, R⁶, R⁷, R₈^{u}, R⁹, R¹⁰, R¹¹, R¹², R¹³, R¹⁴, R¹⁵, R¹⁶, R¹⁷, R¹⁸, R¹⁹, R²⁰, R²¹, R²², R²³R²⁴, R²⁵, R²⁶, and R²⁷ can independently be a substituted C₁ to C₃₀ hydrocarbyl radical, a substituted C₁ to C₂₀ hydrocarbyl radical, or a substituted C₁ to C₁₀ hydrocarbyl radical (such as 4-fluorophenyl, 4-chlorophenyl, 4-bromophenyl, 4-methoxyphenyl, 4-trifluoromethylphenyl, 4-dimethylaminophenyl, 4-trimethylsilylphenyl, 4-triethyl silylphenyl, trifluoromethyl, fluoromethyl, trichloromethyl, chloromethyl, mesityl, methylthio, phenylthio, (trimethylsilyl)methyl, and (triphenylsilyl)methyl).

In some examples, one or more of R*, R″, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³R²⁴, R²⁵, R²⁶, and R²⁷ can be a methyl radical, a fluoride, chloride, bromide, iodide, methoxy, ethoxy, isopropoxy, trifluoromethyl, dimethylamino, diphenylamino, adamantyl, phenyl, pentafluorphenyl, naphthyl, anthracenyl, dimethylphosphanyl, diisopropylphosphanyl, diphenylphosphanyl, methylthio, and phenylthio, or a combination thereof.

In some examples, two or more of R*, R″, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³R²⁴, R²⁵, R²⁶, and R²⁷ can join together to form a cyclic group (single ring or multi-ring, aromatic or saturated).

In some examples, Q* is N, O, S, or P, optionally N, O, or S, optionally N or 0, optionally N. In some examples, when Q* is a group 15 atom, z is 1, and when Q* is a group 16 atom, z is 0.

In any embodiment of the transition metal complexes of Formulas (II), (III), or (IV) described herein, Q is preferably a neutral donor group comprising at least one atom from Group 15 or Group 16, preferably Q is NR′₂, OR′, SR′, PR′₂, where R′ is as defined for R¹ (preferably R′ is methyl, ethyl, propyl, isopropyl, phenyl, cyclohexyl or linked together to form a five-membered ring such as pyrrolidinyl or a six-membered ring such as piperidinyl), preferably the —(˜Q-Y—)— fragment can form a substituted or unsubstituted heterocycle which may or may not be aromatic and may have multiple fused rings (for example, see compound 7-Zr, 7-Hf in U.S. Pat. No. 10,266,622). In any embodiment of the transition metal complexes of Formula (II), (III), or (IV) described herein, Q is preferably an amine, ether, or pyridine.

In some examples, G* and J* can be the same, preferably G* and J* are N, alternately G* and J* are CR′″, where each R′″ is H or a C₁ to C₁₂ hydrocarbyl or substituted hydrocarbyl (such as methyl, ethyl, ethenyl and isomers of propyl, butyl, pentyl, hexyl, heptyl, octyl, nonyl, decyl, undecyl, dodecyl, trifluoromethylphenyl, tolyl, phenyl, methoxyphenyl, tertbutylphenyl, fluorophenyl, diphenyl, dimethylaminophenyl, chlorophenyl, bromophenyl, iodophenyl, (trimethylsilyl)phenyl, (triethyl silyl)phenyl, (triethylsilyl)methyl, and (triethylsilyl)methyl).

In some examples, G* and J* are different. In some examples, G* and J* are N.

In some examples, G and J are the same, preferably G and J are carbazolyl, substituted carbazolyl, indolyl, substituted indolyl, indolinyl, substituted indolinyl, imidazolyl, substituted imidazolyl, indenyl, substituted indenyl, indanyl, substituted indanyl, fluorenyl, or substituted fluorenyl. In some examples, G and J are different, and preferably are independently carbazolyl, substituted carbazolyl, indolyl, substituted indolyl, indolinyl, substituted indolinyl, imidazolyl, substituted imidazolyl, indenyl, substituted indenyl, indanyl, substituted indanyl, fluorenyl, or substituted fluorenyl.

In some examples, M is Zr or Hf; X¹ and X² is benzyl; R¹ is a methyl; R² through R²⁷ are hydrogen; Y is ethylene (—CH₂CH₂—), Q*, G* and J* are N, and Rz* is methyl.

In some examples of the transition metal complexes described herein, M is Zr or Hf; X¹ and X² are benzyl radicals; R⁴ and R⁷ are methyl; R¹ through R³, R⁵ through R⁶, and R through R¹⁰ are hydrogen; Y is ethylene, (—CH₂CH₂—), Q is a N-containing group, and G and J are carbazolyl or fluorenyl. In some examples, G and J can be carbazolyl and Q can be an amine group; or, G and J can be substituted fluorenyl and Q can be an amine, ether or pyridine.

In some examples, the second catalyst can be an ONYO type catalyst represented by the following chemical Formulas (V) and (VI):

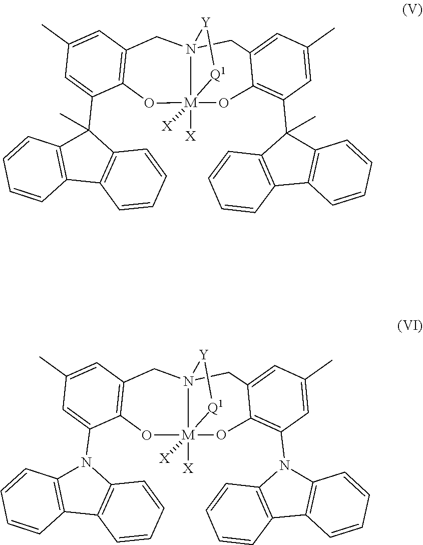

wherein: Y is a C₁-C₃ divalent hydrocarbyl, Q is NR′₂, OR′, SR′, PR′₂, where R′ is as defined for R¹ (preferably R′ is methyl, ethyl, propyl, isopropyl, phenyl, cyclohexyl or linked together to form a five-membered ring such as pyrrolidinyl or a six-membered ring such as piperidinyl), alternately the —(-Q¹-Y—)— fragment can form a substituted or unsubstituted heterocycle, which may or may not be aromatic, and may have multiple fused rings, M is Zr, Hf, or Ti and each X is, independently, as defined for X¹ above, preferably each X is benzyl, methyl, ethyl, chloride, bromide, or alkoxide.

Such ONYO-catalyst materials are known in the art and include, but are not limited to, those disclosed in U.S. Pat. No. 10,266,622, issued on Apr. 23, 2019.

### Support Material

The catalyst systems described herein include a support material. The support material can be a porous support material, for example, talc, and inorganic oxides. Other support materials can include zeolites, clays, organoclays, or any other organic or inorganic support material, or mixtures thereof. As used herein, “support” and “support material” are used interchangeably.

The support material can be an inorganic oxide in a finely divided form. Suitable inorganic oxide materials for use in the supported catalyst systems herein can include groups 2, 4, 13, and 14 metal oxides such as silica, alumina, and mixtures thereof. Other inorganic oxides that can be employed, either alone or in combination, with the silica or alumina are magnesia, titania, zirconia, and the like. Other suitable support materials, however, can be employed, for example, finely divided functionalized polyolefins such as finely divided polyethylene. Particularly useful supports can include magnesia, titania, zirconia, montmorillonite, phyllosilicate, zeolites, talc, clays, and the like. Also, combinations of these support materials can be used, for example, silica-chromium, silica-alumina, silica-titania, and the like. Preferred support materials include Al₂O₃, ZrO₂, SiO₂, and combinations thereof, more preferably, SiO₂, Al₂O₃, or Si₂/A₂O₃.

In some examples, the support material can have a surface area of about 10 m²/g to about 700 m²/g, pore volume of from about 0.1 cc/g to about 4.0 cc/g, and average particle size of from about 5 μm to about 500 μm. In some examples, the surface area of the support material can be from about 50 m²/g to about 500 m²/g, pore volume of from about 0.5 cc/g to about 3.5 cc/g, and average particle size of from about 10 μm to about 200 μm. In some examples, the surface area of the support material can be from about 100 m²/g to about 400 m²/g, pore volume from about 0.8 cc/g to about 3.0 cc/g, and average particle size can be from about 5 μm to about 100 μm. The average pore size of the support material can be from 10 to 1,000 Å, 50 to about 500 Å, or 75 to about 350 Å. In some examples, the support material can be a high surface area amorphous silica (surface area ≥300 m²/gm, pore volume ≥1.65 cm³/gm), such as those marketed under the tradenames of DAVISON 952 or DAVISON 955 by the Davison Chemical Division of W. R. Grace and Company. In some examples, DAVIDSON 948 can be used.

In some examples, the support material can be dry, that is, free of absorbed water. Drying of the support material can be achieved by heating or calcining at about 100° C. to about 1,000° C., or, at least about 600° C. When the support material is silica, it can be typically heated to at least 200° C., about 200° C. to about 850° C., or, at about 600° C.; and for a time of about 1 minute to about 100 hours, from about 12 hours to about 72 hours, or from about 24 hours to about 60 hours. The calcined support material can have at least some reactive hydroxyl (OH) groups.

In some examples, the support material can be fluorided. Fluoriding agent containing compounds can be any compound containing a fluorine atom. Some examples include inorganic fluorine containing compounds selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF 5, BrF₅, IF₇, NF₃, HF, BF₃, NHF₂ and NH₄HF₂. In some examples, ammonium hexafluorosilicate and ammonium tetrafluoroborate are used. Combinations of these compounds can also be used.

Ammonium hexafluorosilicate and ammonium tetrafluoroborate fluorine compounds are typically solid particulates as are the silicon dioxide supports. An exemplary method of treating the support with the fluorine compound is to dry mix the two components by simply blending at a concentration of from 0.01 to 10.0 millimole F/g of support, from 0.05 to 6.0 millimole F/g of support, or from 0.1 to 3.0 millimole F/g of support. The fluorine compound can be dry mixed with the support either before or after charging to a vessel for dehydration or calcining the support. Accordingly, the fluorine concentration present on the support can be from 0.1 to 25 wt %, alternately 0.19 to 19 wt %, alternately from 0.6 to 3.5 wt %, based upon the weight of the support.

The above two metal catalyst components described herein can be generally deposited on the support material at a loading level of 10-100 micromoles of metal per gram of solid support; alternately 20-80 micromoles of metal per gram of solid support; or 40-60 micromoles of metal per gram of support. But greater or lesser values can be used provided that the total amount of solid complex does not exceed the support's pore volume.

### Activators

The catalyst systems described herein include an activator such as alumoxane or a non-coordinating anion and can be formed by combining the catalyst components described herein with the activator in any manner known from the literature including combining them with supports, such as silica. The catalyst systems can have one or more activators. Activators are defined to be any compound which can activate any one of the catalyst compounds described above by converting the neutral metal compound to a catalytically active metal compound cation. Non-limiting activators, for example, include alumoxanes, aluminum alkyls, ionizing activators, which can be neutral or ionic, containing a non-coordinating anion. Preferred activators typically include alumoxane compounds, modified alumoxane compounds, and ionizing anion precursor compounds that abstract a reactive, 6-bound, metal ligand making the metal compound cationic and providing a charge-balancing non-coordinating or weakly coordinating anion, e.g. a non-coordinating anion.

### Alumoxane Activators

Alumoxane activators can be utilized as activators in the catalyst systems described herein. Alumoxanes are generally oligomeric compounds containing —Al(R¹)—O— sub-units, where R¹ can be an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand can be an alkyl, halide, alkoxide or amide. Mixtures of different alumoxanes and modified alumoxanes can also be used. In some examples, a visually clear methylalumoxane can be used. A cloudy or gelled alumoxane can be filtered to produce a clear solution or clear alumoxane can be decanted from the cloudy solution. In some examples, a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584) can be used.

When the activator is an alumoxane (modified or unmodified), some examples select the maximum amount of activator typically at up to a 5,000-fold molar excess Al/M over the catalyst compound (per metal catalytic site). The minimum activator-to-catalyst-compound can be a 1:1 molar ratio. Alternate ranges include from 1:1 to 500:1, alternately from 1:1 to 200:1, alternately from 1:1 to 100:1, or alternately from 1:1 to 50:1.

In some examples, little or no alumoxane can be used in the polymerization processes described herein. Alumoxane can be present at zero mole %, alternately the alumoxane can be present at a molar ratio of aluminum to catalyst compound of less than 500:1, less than 300:1, less than 100:1, or less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a neutral Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with some examples are those that are compatible, stabilize the transition metal cation in the sense of balancing its ionic charge at +1, and yet retain sufficient lability to permit displacement during polymerization. Ionizing activators useful herein include an NCA, particularly a compatible NCA.

In some examples, an ionizing activator, neutral or ionic can be used. It is also within the scope of this invention to use neutral or ionic activators alone or in combination with alumoxane or modified alumoxane activators. Suitable activators can include those disclosed in U.S. Pat. Nos. 8,658,556 and 6,211,105.

In some examples, the activator comprises one or more of; N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl)pyrrolidinium; tetrakis(pentafluorophenyl)borate tetrakis(pentafluorophenyl)borate, 4-(tris(pentafluorophenyl)borate)-2,3,5,6-tetrafluoropyridine, or any mixture thereof.

In some examples, the activator is a triaryl carbonium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbeniumtetrakis(3,5-bis(trifluoromethyl)phenyl)borate).

In some examples, the activator is one or more of trialkylammonium tetrakis(pentafluorophenyl)borate, N,N-dialkylanilinium tetrakis(pentafluorophenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis(perfluoronaphthyl)borate, N,N-dialkylanilinium tetrakis(perfluoronaphthyl)borate, trialkylammonium tetrakis(perfluorobiphenyl)borate, N,N-dialkylanilinium tetrakis(perfluorobiphenyl)borate, trialkylammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl can be methyl, ethyl, propyl, n-butyl, sec-butyl, or t-butyl).

In some examples, the activator is represented by the formula: (Z)_{d}+(A^{d-}), where Z can be (L-H) or a reducible Lewis Acid, L can be an neutral Lewis base; H can be hydrogen; (L-H)⁺ can be a Bronsted acid; A^{d-} can be a non-coordinating anion having the charge d-; and d can be an integer from 1 to 3, Z can be (Ar₃C+), where Ar can be aryl or aryl substituted with a heteroatom, a C₁ to C₄₀ hydrocarbyl, or a substituted C₁ to C₄₀ hydrocarbyl.

The activator-to-catalyst ratio, e.g., all NCA activators-to-catalyst ratio can be about a 1:1 molar ratio. Alternate ranges include from 0.1:1 to 100:1, alternately from 0.5:1 to 200:1, alternately from 1:1 to 500:1 alternately from 1:1 to 1000:1, 0.5:1 to 10:1, or 1:1 to 5:1.

The catalyst compounds can be combined with combinations of alumoxanes and NCA's. The combining of catalyst compounds with combinations of alumoxanes is disclosed in U.S. Pat. Nos. 5,153,157 and 5,453,410; EP Patent No.: 0573120; and WO Publication Nos.: WO 1994/07928; and WO 1995/14044.

In addition to the activator compounds, scavengers, chain transfer agents or co-activators can be used. Aluminum alkyl or organoaluminum compounds which can be utilized as co-activators include, for example, trimethylaluminum, triethylaluminum, triisobutylaluminum, tri-n-hexylaluminum, tri-n-octylaluminum, and diethyl zinc.

In some examples, the catalyst systems can additionally include one or more scavenging compounds. The term “scavenger” means a compound that removes polar impurities from the reaction environment. Polar impurities can adversely affect catalyst activity and stability. Typically, the scavenging compound can be an organometallic compound such as the group-13 organometallic compounds of U.S. Pat. Nos. 5,153,15 and 5,241,025; and WO Publication Nos.: WO 1991/009882; WO 1994/003506; WO 1993/014132; and that of WO 1995/007941. Exemplary compounds include triethyl aluminum, triethyl borane, tri-iso-butyl aluminum, methyl alumoxane, iso-butyl alumoxane, and tri-n-octyl aluminum. Those scavenging compounds having bulky or C₆-C₂₀ linear hydrocarbyl substituents connected to the metal or metalloid center usually minimize adverse interaction with the active catalyst. Examples include triethyl aluminum, and bulky compounds such as tri-iso-butyl aluminum, tri-iso-prenyl aluminum, and long-chain linear alkyl-substituted aluminum compounds, such as tri-n-hexyl aluminum, tri-n-octyl aluminum, or tri-n-dodecyl aluminum. When alumoxane is used as the activator, any excess over that needed for activation will scavenge impurities and additional scavenging compounds can be unnecessary. Alumoxanes also can be added in scavenging quantities with other activators, e.g., methylalumoxane, [Me₂HNPh]⁺[B(pfp)₄]⁻ or B(pfp)₃ (perfluorophenyl=pfp=C₆F₅).

Aluminum scavengers can include those where there is oxygen present. That is, the material per se or the aluminum mixture used as a scavenger, includes an aluminum/oxygen species, such as an alumoxane or alkylaluminum oxides, e.g., dialkyaluminum oxides, such as bis(diisobutylaluminum) oxide. In one aspect, aluminum containing scavengers can be represented by the formula ((R_{z}—Al—)_{y}O—)ₓ, wherein z can be 1-2, y can be 1-2, x can be 1-100, and R can be a C₁-C₁₂ hydrocarbyl group. In another aspect, the scavenger can have an oxygen to aluminum (O/Al) molar ratio of from about 0.25 to about 1.5, more particularly from about 0.5 to about 1.

### Preparation of Mixed Catalyst Systems

The above two catalysts components can be combined to form a catalyst system. The two or more catalysts can be added together in a desired ratio when combined, contacted with an activator, and/or contacted with a support material or a supported activator. The catalysts can be added to the mixture sequentially or at the same time.

More complex procedures are possible, such as addition of a first catalyst to a slurry including a support or a supported activator mixture for a specified reaction time, followed by the addition of the second catalyst, mixed for another specified time, after which the mixture can be recovered for use in a polymerization reactor, such as by spray drying. Lastly, another additive, such as 1-hexene in about 10 vol % can be present in the mixture prior to the addition of the first catalyst compound.

The first catalyst compound can be supported via contact with a support material for a reaction time. The resulting supported catalyst composition can then be mixed with mineral oil to form a slurry, which may or may not include an activator. The slurry can then be admixed with a second catalyst compound prior to introduction of the resulting mixed catalyst system to a polymerization reactor. The second catalyst compound can be admixed at any point prior to introduction to the reactor, such as in a polymerization feed vessel or in-line in a catalyst delivery system.

The mixed catalyst system can be formed by combining a first catalyst compound (for example a catalyst compound useful for producing a first polymer attribute, such as a high molecular weight polymer fraction or high comonomer content) with a support and activator, in a first diluent such as an alkane or toluene, to produce a supported, activated catalyst compound. The supported activated catalyst compound, either isolated from the first diluent or not, can then combined with a high viscosity diluent such as mineral or silicon oil, or an alkane diluent having from 5 to 99 wt % mineral or silicon oil to form a slurry of the supported catalyst compound, followed by, or simultaneous to combining with a second catalyst compound (for example a metal compound useful for producing a second polymer attribute, such as a low molecular weight polymer fraction or low comonomer content), either in a diluent or as the dry solid compound, to form a supported activated mixed catalyst system (“mixed catalyst system”). The mixed catalyst system thus produced can be a supported and activated first catalyst compound in a slurry, the slurry can include mineral or silicon oil, with a second catalyst compound that is not supported and not combined with additional activator, where the second catalyst compound may or may not be partially or completely soluble in the slurry. In some examples, the diluent consists of mineral oil.

Mineral oil, or “high viscosity diluents,” as used herein refers to petroleum hydrocarbons and mixtures of hydrocarbons that can include aliphatic, aromatic, and/or paraffinic components that are liquids at 23° C. and above, and can have a molecular weight of at least 300 amu to 500 amu or more, and a viscosity at 40° C. of from 40 to 300 cSt or greater, or from 50 to 200 cSt. The term “mineral oil” includes synthetic oils or liquid polymers, polybutenes, refined naphthenic hydrocarbons, and refined paraffins known in the art, such as disclosed in Blue Book (2001) “Materials, Compounding Ingredients, Machinery And Services For Rubber” v.189 p. 247 (J. H. Lippincott, D. R. Smith, K. Kish & B. Gordon eds. Lippincott & Peto Inc.).

The diluent can include a blend of a mineral oil, silicon oil, and/or and a hydrocarbon selected from the group consisting of C₁ to C₁₀ alkanes, C₆ to C₂ aromatic hydrocarbons, C₇ to C₂₁ alkyl-substituted hydrocarbons, and mixtures thereof. When the diluent is a blend including mineral oil, the diluent can include from 5 to 99 wt % mineral oil. In some examples, the diluent can consist essentially of mineral oil.

In some examples, the first catalyst compound can be combined with an activator and a first diluent to form a catalyst slurry that then combined with a support material. The first catalyst compound can be in any desirable form such as a dry powder, suspension in a diluent, solution in a diluent, liquid, etc. The catalyst slurry and support particles can then be mixed thoroughly, at an elevated temperature, so that both the first catalyst compound and the activator are deposited on the support particles to form a support slurry.

After the first catalyst compound and activator are deposited on the support, a second catalyst compound can then be combined with the supported first catalyst compound, wherein the second catalyst can be combined with a diluent having mineral or silicon oil by any suitable means either before, simultaneous to, or after contacting the second catalyst compound with the supported first catalyst compound. In some examples, the first catalyst compound can be isolated form the first diluent to a dry state before combining with the second catalyst compound. The second catalyst compound can be not activated, that is, not combined with any activator, before being combined with the supported first catalyst compound. The resulting solids slurry (including both the supported first and second catalyst compounds) can then be mixed thoroughly at an elevated temperature.

A wide range of mixing temperatures can be used at various stages of making the mixed catalyst system. For example, when the first catalyst compound and at least one activator, such as methylalumoxane, are combined with a first diluent to form a mixture, the mixture can be heated to a first temperature of from 25° C. to 150° C., from 50° C. to 125° C., from 75° C. to 100° C., from 80° C. to 100° C. and stirred for a period of time from 30 seconds to 12 hours, from 1 minute to 6 hours, more preferably, from 10 minutes to 4 hours, or from 30 minutes to 3 hours. Next, that mixture can be combined with a support material to provide a first support slurry. The support material can be heated, or dehydrated if desired, prior to combining. In some examples, the first support slurry can be mixed at a temperature greater than 50° C., greater than 70° C., greater than 80° C. or, greater than 85° C., for a period of time from 30 seconds to 12 hours from 1 minute to 6 hours, from 10 minutes to 4 hours, or from 30 minutes to 3 hours. The support slurry can be mixed for a time sufficient to provide a collection of activated support particles that have the first catalyst compound deposited thereto. The first diluent can then be removed from the first support slurry to provide a dried supported first catalyst compound. For example, the first diluent can be removed under vacuum or by nitrogen purge.

The second catalyst compound can be combined with the activated first catalyst compound in the presence of a diluent having mineral or silicon oil in some examples. The second catalyst compound can be added in a molar ratio to the first catalyst compound in the range from 1:1 to 3:1. The molar ratio can be approximately 1:1. The resultant slurry (or first support slurry) can be heated to a first temperature from 25° C. to 150° C., from 50° C. to 125° C., from 75° C. to 100° C., or from 80° C. to 100° C. and stirred for a period of time from 30 seconds to 12 hours, from 1 minute to 6 hours, from 10 minutes to 4 hours, or from 30 minutes to 3 hours.

The first diluent can be an aromatic or alkane, preferably, hydrocarbon diluent having a boiling point of less than 200° C. such as toluene, xylene, hexane, etc., and can be removed from the supported first catalyst compound under vacuum or by nitrogen purge to provide a supported mixed catalyst system. Even after addition of the oil and/or the second (or other) catalyst compound, it can be desirable to treat the slurry to further remove any remaining solvents such as toluene. This can be accomplished by an N₂ purge or vacuum, for example. Depending upon the level of mineral oil added, the resultant mixed catalyst system can still be a slurry or can be a free-flowing powder that includes an amount of mineral oil. Thus, the mixed catalyst system, while a slurry of solids in mineral oil in some examples, can take any physical form such as a free flowing solid. For example, the mixed catalyst system can range from 1 to 99 wt % solids content by weight of the mixed catalyst system (mineral oil, support, all catalyst compounds and activator(s)) in some examples.

### Polymerization Process

In some examples, a monomer (such as ethylene), and, optionally, a comonomer (such as hexene), can be contacted with a supported catalyst system including a first catalyst, a second catalyst, an activator and a support material as described above to polymerize the monomer and, if present, the comonomer.

The monomer can be substituted or unsubstituted C₂ to C₄₀ alpha olefins, C₂ to C₂₀ alpha olefins, C₂ to C₁₂ alpha olefins, ethylene, propylene, butene, pentene, hexene, heptene, octene, nonene, decene, undecene, dodecene and isomers thereof. In some examples, the monomers can include ethylene and, optional, comonomers including one or more C₃ to C₄₀ olefins, C₄ to C₂₀ olefins, or C₆ to C₁₂ olefins. The C₃ to C₄₀ olefin monomers can be linear, branched, or cyclic. The C₃ to C₄₀ cyclic olefins can be strained or unstrained, monocyclic or polycyclic, and can, optionally, include heteroatoms and/or one or more functional groups.

Exemplary C₃ to C₄₀ comonomers include propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably, hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives.

In some examples, one or more dienes can be present in the polymer at up to 10 wt %, at 0.00001 to 1.0 wt %, 0.002 to 0.5 wt %, or 0.003 to 0.2 wt %, based upon the total weight of the composition. In some examples, 500 ppm or less of diene can be added to the polymerization, 400 ppm or less, or 300 ppm or less. In other examples, at least 50 ppm of diene can be added to the polymerization, or 100 ppm or more, or 150 ppm or more.

In some examples, the diolefin monomers can be any hydrocarbon structure or C₄ to C₃₀ having at least two unsaturated bonds, wherein at least two of the unsaturated bonds are readily incorporated into a polymer by either a stereospecific or a non-stereospecific catalyst(s). In some examples, the diolefin monomers can be alpha, omega-diene monomers (i.e., di-vinyl monomers). The diolefin monomers can be linear di-vinyl monomers, n some examples, those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, or low molecular weight polybutadienes (M_{w} less than 1000 g/mol). Cyclic dienes can include cyclopentadiene, vinylnorbornene, norbornadiene, ethylidene norbornene, divinylbenzene, dicyclopentadiene or higher ring containing diolefins with or without substituents at various ring positions.

In some examples, ethylene and at least one comonomer having from 3 to 8 carbon atoms or 4 to 8 carbon atoms are polymerized. The comonomers can be propylene, 1-butene, 4-methyl-1-pentene, 3-methyl-1-pentene, or 1-hexene and 1-octene.

Polymerization can be carried out in any manner known in the art. In particular suspension, bulk, slurry, or gas phase polymerization process known in the art can be used. Such processes can be run in a batch, semi-batch, or continuous mode. Gas phase polymerization processes and slurry processes can be used. A bulk homogeneous polymerization process can be used. (A bulk process can be defined to be a process where monomer concentration in all feeds to the reactor is 70 volume % or more.) Alternately, no solvent or diluent can be present or added in the reaction medium, (except for the small amounts used as the carrier for the catalyst system or other additives, or amounts typically found with the monomer; e.g., propane in propylene). In some examples, the polymerization process can be a slurry process. As used herein, the term “slurry polymerization process” means a polymerization process where a supported catalyst can be employed and monomers are polymerized on the supported catalyst particles. At least 95 wt % of polymer products derived from the supported catalyst can be in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorided C₄₋₁₀ alkanes, chlorobenzene, and aromatic and alkylsubstituted aromatic compounds, such as benzene, toluene, mesitylene, and xylene. Suitable solvents also include liquid olefins, which can act as monomers or comonomers, including ethylene, propylene, 1-butene, 1-hexene, 1-pentene, 3-methyl-1-pentene, 4-methyl-1-pentene, 1-octene, 1-decene, and mixtures thereof. In some examples, aliphatic hydrocarbon solvents can be as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In some examples, the solvent can be not aromatic. In some examples, aromatics are present in the solvent at less than 1 wt %, preferably, less than 0.5 wt %, preferably, or less than 0.1 wt % based upon the weight of the solvents.

### Gas Phase Polymerization

Generally, in a fluidized gas bed process used for producing polymers, a gaseous stream containing one or more monomers can be continuously cycled through a fluidized bed in the presence of a catalyst under reactive conditions. The gaseous stream can be withdrawn from the fluidized bed and recycled back into the reactor. Simultaneously, polymer product can be withdrawn from the reactor and fresh monomer can be added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228).

### Slurry Phase Polymerization

A slurry polymerization process generally operates between 1 to about 50 atmosphere pressure range (15 psi to 735 psi, 103 kPa to 5068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process must be operated above the reaction diluent critical temperature and pressure. Preferably, a hexane or an isobutane medium is employed.

### Polyolefin Products

In some examples, a process described herein produces ethylene homopolymers or ethylene copolymers, such as ethylene-alpha-olefin (preferably C₃ to C₂₀) copolymers (such as ethylene-butene copolymers, ethylene-hexene and/or ethylene-octene copolymers). In some examples, the copolymers produced herein have from 0 to 25 mol % (alternatively from 0.5 to 20 mol %, alternatively from 1 to 15 mol %, preferably from 3 to 10 mol %) of one or more C₃ to C₂₀ olefin comonomer, such as a C₃-C₂₀ alpha-olefin, (preferably C₃ to C₁₂ alpha-olefin, preferably propylene, butene, hexene, octene, decene, dodecene, preferably propylene, butene, hexene, octene). In some examples, the monomer is ethylene and the comonomer is hexene and can include from 1 to 15 mol % hexene or 1 to 10 mol % hexene.

In some examples, a method of the present invention provides an in-situ ethylene polymer composition having: 1) at least 50 mol % ethylene; and 2) a density of 0.91 g/cc or more, preferably 0.935 g/cc or more (ASTM D1505-18). The copolymer can have higher comonomer (e.g., hexene) content in the higher molecular weight (Mw) component of the resin as compared to the lower molecular weight (Mw) component, at least 10% higher, at least 20% higher, at least 30% higher as determined by GPC-4D described herein. The dividing line between higher and lower Mw is the midpoint between the Mw's of two polymers each made using the same polymerization conditions as the product made using the two catalysts on a support. In the event such a midpoint cannot be determined because one or both single catalysts will not produce polymer at the required conditions then an Mw of 150,000 g/mol shall be used.

In some examples, the copolymer produced herein can have a composition distribution breadth T₇₅-T₂₅, as measured by TREF, that is greater than 20° C., greater than 30° C., greater than 40° C. The T₇₅-T₂₅ value represents the homogeneity of the composition distribution as determined by temperature rising elution fractionation. A TREF curve is produced as described herein. Then the temperature at which 75% of the polymer is eluted is subtracted from the temperature at which 25% of the polymer is eluted, as determined by the integration of the area under the TREF curve. The T₇₅-T₂₅ value represents the difference. The closer these temperatures comes together, the narrower the composition distribution.

In some examples, the polymers produced herein have an Mw of 5,000 to 1,000,000 g/mol (25,000 to 750,000 g/mol, 50,000 to 500,000 g/mol), and/or an Mw/Mn of greater than 1 to 40 (alternatively 1.2 to 20, alternatively 1.3 to 10, alternatively 1.4 to 5, 1.5 to 4, alternatively 1.5 to 3) as determined by GPC-4D described herein. Polymers produced herein can have an Mz/Mw from about 1 to about 10, such as from about 2 to about 6, such as from about 3 to about 5. Polymers produced herein can have an Mz/Mn from about 1 to about 10, such as from about 2 to about 6, such as from about 3 to about 5. Furthermore, the ratio of other average molecular weight ratios can also be calculated to highlight how the distribution is affected. For instance, a trace amount of very high MW species in a polymer product can raise Mz more than Mw and, therefore, result in a significantly higher ratio of Mz/Mw. Such difference in the effect on molecular weight distribution has been discovered to have profound effects on film toughness, such as tear property, through molecular orientation during the fabrication process.

In some examples, the polymer produced herein has a unimodal or multimodal molecular weight distribution as determined by Gel Permeation Chromatography (GPC-4D). By “unimodal” is meant that the GPC trace has one peak or two inflection points. By “multimodal” is meant that the GPC trace has at least two peaks or more than 2 inflection points. An inflection point is that point where the second derivative of the curve changes in sign (e.g., from negative to positive or vice versa).

In some examples, the polymer produced herein has a bimodal molecular weight distribution as determined by Gel Permeation Chromatography (GPC). By “bimodal” is meant that the GPC trace has two peaks or at least four inflection points.

In some examples, the polymer produced herein has two peaks in the TREF measurement (see below). Two peaks in the TREF measurement as used in this specification and the appended claims means the presence of two distinct normalized IR response peaks in a graph of normalized IR response (vertical or y axis) versus elution temperature (horizontal or x axis with temperature increasing from left to right) using the TREF method below. A “peak” in this context means where the general slope of the graph changes from positive to negative with increasing temperature. Between the two peaks is a local minimum in which the general slope of the graph changes from negative to positive with increasing temperature. “General trend” of the graph is intended to exclude the multiple local minimums and maximums that can occur in intervals of 2° C. or less. The two distinct peaks are at least 3C apart, more preferably at least 4° C. apart, even more preferably at least 5° C. apart. Additionally, both of the distinct peaks occur at a temperature on the graph above 20° C. and below 120° C. where the elution temperature is run to 0° C. or lower. This limitation avoids confusion with the apparent peak on the graph at low temperature caused by material that remains soluble at the lowest elution temperature. Two peaks on such a graph indicates a bi-modal composition distribution (CD).

An “in-situ polymer composition” (also referred to as an “in-situ blend” or a “reactor blend”) is the composition which is the product of a polymerization with two catalyst compounds in the same reactor described herein. Without wishing to be bound by theory it is thought that the two catalyst compounds produce a reactor blend (i.e. an interpenetrating network) of two (or more) components made in the same reactors (or reactions zones) with the two catalysts. In the literature, these sorts of compositions may be referred to as reactor blends, although the term may not be strictly accurate since there may be polymer species comprising components produced by each catalyst compound that are not technically a blend.

An “ex-situ blend” is a blend which is a physical blend of two or more polymers synthesized independently and then subsequently blended together typically using a melt-mixing process, such as an extruder. An ex-situ blend is distinguished by the fact that the polymer components are collected in solid form after exiting their respective synthesis processes, and then combined to form the blend; whereas for an in-situ polymer composition, the polymer components are prepared within a common synthesis process and only the combination is collected in solid form.

In some examples, the polymer composition produced can be an in-situ polymer composition. In some examples, the polymer produced can be an in-situ polymer composition having an ethylene content of 70 wt % or more, 80 wt % or more, 90 wt % or more and/or a density of 0.910 or more, alternately 0.93 g/cc or more; alternately 0.935 g/cc or more, alternately 0.938 g/cc or more. In some examples, the polymer produced is an in-situ polymer composition having a density of 0.910 g/cc or more, alternately from 0.935 to 0.960 g/cc.

GPC 4D Procedure: Molecular Weight, Comonomer Composition and Long Chain Branching Determination by GPC-IR Hyphenated with Multiple Detectors

Unless otherwise indicated, the distribution and the moments of molecular weight (Mw, Mn, Mw/Mn, etc.), the comonomer content (C₂, C₃, C₆, etc.) and the branching index (g′) are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10-μm Mixed-B LS columns are used to provide polymer separation. Aldrich reagent grade 1,2,4-trichlorobenzene (TCB) with 300 ppm antioxidant butylated hydroxytoluene (BHT) is used as the mobile phase. The TCB mixture is filtered through a 0.1-μm Teflon filter and degassed with an online degasser before entering the GPC instrument. The nominal flow rate is 1.0 m/min and the nominal injection volume is 200 μL. The whole system including transfer lines, columns, and detectors are contained in an oven maintained at 145° C. Given amount of polymer sample is weighed and sealed in a standard vial with 80-μL flow marker (Heptane) added to it. After loading the vial in the autosampler, polymer is automatically dissolved in the instrument with 8 ml added TCB solvent. The polymer is dissolved at 160° C. with continuous shaking for about 1 hour for most PE samples or 2 hour for PP samples. The TCB densities used in concentration calculation are 1.463 g/ml at room temperature and 1.284 g/ml at 145° C. The sample solution concentration is from 0.2 to 2.0 mg/ml, with lower concentrations being used for higher molecular weight samples. The concentration (c), at each point in the chromatogram is calculated from the baseline-subtracted IR5 broadband signal intensity (I), using the following equation: c=βI, where β is the mass constant determined with PE or PP standards. The mass recovery is calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{P S} \text{/} K )}{a + 1} + \frac{{a}_{P S} + 1}{a + 1} log {M}_{P S}$$

where the variables with subscript “PS” stand for polystyrene while those without a subscript are for the test samples. In this method, a_{PS}=0.67 and K_{PS}=0.000175 while a and K are for other materials are as calculated as published in literature (Sun, T. et al. (2001) Macromolecules, v.34, 6812.), except that for purposes of this invention and the claims thereto, α and K are 0.705 and 0.0002288 respectively for propylene polymers; α=0.695 and k=0.000181 for linear butene polymers; α and K are 0.695 and 0.000579 respectively, for ethylene polymers, except that a and K are 0.695 and 0.000579*(1-0.0075*wt % hexene comonomer), respectively, for ethylene-hexene copolymers.

The comonomer composition is determined by the ratio of the IR5 detector intensity corresponding to CH₂ and CH₃ channel calibrated with a series of PE and PP homo/copolymer standards whose nominal value are predetermined by NMR or FTIR.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K₀ is the optical constant for the system:

$${K}_{o} = \frac{4 {π}^{2} {{n}^{2} ( dn \text{/} d c )}^{2}}{{λ}^{4} {N}_{A}}$$

where N_{A} is Avogadro's number, and (dn/dc) is the refractive index increment for the system. The refractive index, n=1.500 for TCB at 145° C. and λ=665 nm. For the ethylene-hexene copolymers analyzed, dn/dc=0.1048 ml/mg and A₂=0.0015.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the equation [η]=ηₛ/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{a v g}}{k {M}_{v}^{α}} ,$$

where My is the viscosity-average molecular weight based on molecular weights determined by LS analysis and the K and α for the reference linear polymer, are as calculated as published in literature (Sun, T. et al. (2001) Macromolecules, v.34, pg. 6812), except that for purposes of this invention and the claims thereto, α and K are 0.705 and 0.0002288 respectively for propylene polymers; α=0.695 and λ=0.000181 for linear butene polymers; α and K are 0.695 and 0.000579 respectively, for ethylene polymers, except that α and K are 0.695 and 0.000579*(1-0.0075*wt % hexene comonomer), respectively, for ethylene-hexene copolymers. Concentrations are expressed in g/cm³, molecular weight is expressed in g/mole, and intrinsic viscosity is expressed in dL/g unless otherwise noted.

### End Uses

The multi-modal polyolefin produced by the processes disclosed herein and blends thereof can be useful in such forming operations as film, sheet, and fiber extrusion and co-extrusion as well as blow molding, injection molding, and rotary molding. Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, membranes, etc., in food-contact and non-food contact applications. Fibers include melt spinning, solution spinning and melt blown fiber operations for use in woven or non-woven form to make filters, diaper fabrics, medical garments, geotextiles, etc. Extruded articles include medical tubing, wire and cable coatings, pipe, geomembranes, and pond liners. Molded articles include single and multi-layered constructions in the form of bottles, tanks, large hollow articles, rigid food containers and toys, etc.

Specifically, any of the foregoing polymers, such as the foregoing ethylene copolymers or blends thereof, may be used in mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents.

The polymers produced herein may be further blended with additional ethylene polymers (referred to as “second ethylene polymers” or “second ethylene copolymers”) and use in film, molded part and other typical polyethylene applications.

In some examples, the second ethylene polymer can be ethylene homopolymers, ethylene copolymers, and blends thereof. Useful second ethylene copolymers can include one or more comonomers in addition to ethylene and can be a random copolymer, a statistical copolymer, a block copolymer, and/or blends thereof. The method of making the second ethylene polymer is not critical, as it can be made by slurry, solution, gas phase, high pressure or other suitable processes, and by using catalyst systems appropriate for the polymerization of polyethylenes, such as Ziegler-Natta-type catalysts, chromium catalysts, metallocene-type catalysts, other appropriate catalyst systems or combinations thereof, or by free-radical polymerization. In a preferred embodiment, the second ethylene polymers are made by the catalysts, activators and processes described in U.S. Pat. Nos. 6,342,566; 6,384,142; 5,741,563; PCT publications WO 2003/040201; and 1997/019991. Such catalysts are well known in the art, and are described in, for example, Ziegler Catalysts (Gerhard Fink, Rolf Mulhaupt and Hans H. Brintzinger, eds., Springer-Verlag 1995); Resconi et al.; and I, II Metallocene-based Polyolefins (Wiley & Sons 2000). Additional useful second ethylene polymers and copolymers are described at paragraph [00118] to [00126] at pages 30 to 34 of PCT/US2016/028271, filed Apr. 19, 2016.

This invention further relates to:

1. A supported catalyst system comprising a first catalyst, a second catalyst, a support material, and an activator; wherein the first catalyst is represented by the Formula (I):

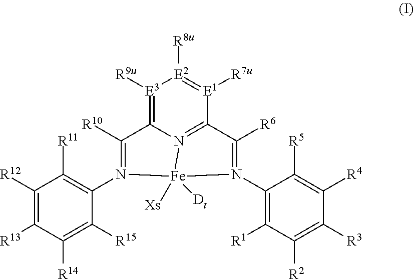

where R¹, R⁵, R¹¹, and R¹⁵ are independently C₁-C₄₀ hydrocarbyl, C₁-C₄₀ substituted hydrocarbyl group, heteroatom or heteroatom-containing group,

R⁷ᵤ, R⁸ᵤ, R⁹ᵤ, R², R³, R⁴, R⁶, R¹⁰, R¹², R¹³, and R¹⁴ are independently hydrogen, C₁-C₄₀ hydrocarbyl, C₁-C₄₀ substituted hydrocarbyl group, heteroatom or heteroatom-containing group, wherein two or more of R⁷ᵤ, R₈^{u}, R⁹ᵤ, R¹, R², R³, R⁴, R⁵, R⁶, R¹⁰, R¹¹, R¹², R¹³, R¹⁴, and R¹⁵, may independently join together to form a C₄ to C₆₂ cyclic or polycyclic ring structure;

E¹, E², and E³ are independently C, N, or P;

each u is independently 0 if E¹, E², and/or E³ is N or P and is 1 if E¹, E², and/or E³ is C;

X is hydrogen, C₁-C₄₀ hydrocarbyl, C₁-C₄₀ substituted hydrocarbyl group, heteroatom or heteroatom-containing group;

s is 1, 2, or 3;

D is a neutral donor; and

t is 0, 1, or 2; and

wherein the second catalyst is represented by the Formula (II):

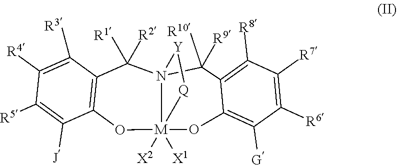

wherein:
M is a group 4 transition metal;
X¹ and X² are independently C₁-C₄₀ hydrocarbyl, C₁-C₄₀ substituted hydrocarbyl, heteroatom or heteroatom-containing group, wherein X¹ optionally bonds with X² to form a C₄ to C₆₂ cyclic or polycyclic ring structure;
R^{1′}, R^{2′}, R^{3′}, R^{4′}, R^{5′}, R^{6′}, R^{7′}, R^{8′}, R^{9′}, and R^{10′} are independently hydrogen, C₁-C₄₀ hydrocarbyl, C₁-C₄₀ substituted hydrocarbyl group, heteroatom or heteroatom-containing group, where two or more of R^{1′} to R^{10′}, J′ and G′ may independently join together to form a C₄ to C₆₂ cyclic or polycyclic ring structure;
J′ is a C₇ to C₆₀ fused polycyclic group, which optionally includes up to 20 atoms from groups 15 and 16, wherein at least one ring can be aromatic and wherein at least one ring, which may or may not be aromatic, has at least five members;
G′ is hydrogen, C₁ to C₆₀ hydrocarbyl, C₁-C₆₀ substituted hydrocarbyl group, a heteroatom or heteroatom-containing group or optionally as defined for J′;
Y is hydrogen, C₁-C₄₀ hydrocarbyl, C₁-C₄₀ substituted hydrocarbyl group, heteroatom or heteroatom-containing group; and
Q is a neutral donor group.
   2. The supported catalyst system of paragraph 1, wherein M is Hf or Zr.
   3. The supported catalyst system of paragraph 1 or 2, where in Formula (I), R¹ optionally bonds with R², R² optionally bonds with R³, R³ optionally bonds with R⁴, R⁴ optionally bonds with R⁵, R⁵ optionally bonds with R⁶, R⁶ optionally bonds with R⁷, R⁷ optionally bonds with R⁸, R⁸ optionally bonds with R⁹, R⁹ optionally bonds with R¹⁰, R¹ optionally bonds with R¹¹, R¹¹ optionally bonds with R¹², R¹² optionally bonds with R¹³, R¹³ optionally bonds with R¹⁴, and R¹⁴ optionally bonds with R¹⁵, in each case to independently form a five-, six- or seven-membered ring; and

in Formula (II) for example, R′ optionally bonds with R^{2′}, and R^{2′} optionally bonds with R^{3′}, R^{3′} optionally bonds with R^{4′}, R^{4′} optionally bonds with R^{5′}, R^{5′} optionally bonds with J′, G′ optionally bonds with R^{6′}, R^{6′} optionally bonds with R^{7′}, R^{7′} optionally bonds with R′, R′ optionally bonds with R^{9′}, R^{9′} optionally bonds with R^{10′} in each case to independently form a five-, six- or seven-membered ring.

4. The supported catalyst system of paragraph 1, wherein the first catalyst is one or more of:
bis(2,6-[1-(2,6-dimethylphenylimino)ethyl])pyridineirondichloride,
bis(2,6-[1-(2,4,6-trimethylphenylimino)ethyl)])pyridineirondichloride,
bis(2,6-[1-(2,6-dimethylphenylimino)ethyl]-ethyl])pyridineirondichloride,
2-[1-(2,4,6-trimethylphenylimino)ethyl]-6-[1-(2,4-dichloro-6-methylphenylimino)ethyl]pyridineiron dichloride,
2-[1-(2,6-dimethylphenylimino)ethyl]-6-[1-(2-chloro-6-methylphenylimino)ethyl]pyridineiron dichloride,
2-[1-(2,4,6-trimethylphenylimino)ethyl]-6-[1-(2-chloro-6-methylphenylimino)ethyl]pyridineiron dichloride,
2-[1-(2,6-diisopropylphenylimino)ethyl]-6-[1-(2-chloro-6-methylphenylimino)ethyl]pyridineiron dichloride,
2-[1-(2,6-dimethylphenylimino)ethyl]-6-[1-(2-bromo-4,6-dimethylphenylimino)ethyl]pyridineiron dichloride,
2-[1-(2,4,6-trimethylphenylimino)ethyl]-6-[1-(2-bromo-4,6-dimethylphenylimino)ethyl]pyridineiron dichloride,
2-[1-(2,6-dimethylphenylimino)ethyl]-6-[1-(2-bromo-6-methylphenylimino)ethyl]pyridineiron dichloride,
2-[-(2,4,6-trimethylphenylimino)ethyl]-6-[1-(2-bromo-6-methylphenylimino)ethyl]pyridineiron dichloride, and
2-[1-(2,6-diisopropylphenylimino)ethyl]-6-[-(2-bromo-6-methylphenylimino)ethyl]pyridineiron dichloride, or the dibromides or tribromides thereof.
   5. The supported catalyst system of paragraph 1 or 4 wherein, the second catalyst is represented Formulas (V) or (VI):

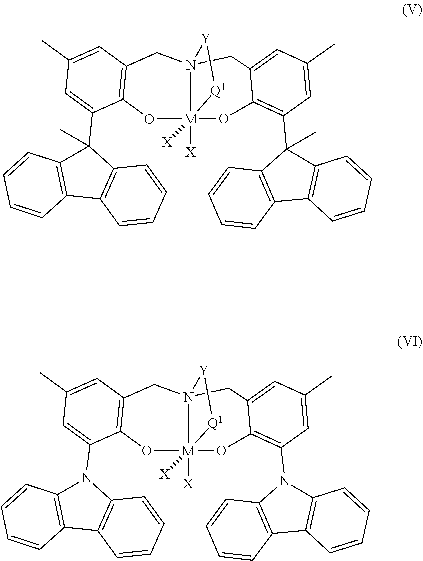

wherein:

Y is a C₁-C₃ divalent hydrocarbyl, Q¹ is NR′₂, OR′, SR′, PR′₂, where R′ is hydrogen, C₁-C₄₀ hydrocarbyl, C₁-C₄₀ substituted hydrocarbyl group, heteroatom or heteroatom-containing group, alternately the —(-Q¹-Y—)— fragment can form a substituted or unsubstituted heterocycle, which may or may not be aromatic, and may have multiple fused rings, M is Zr, Hf, or Ti and each X is, independently, as defined for X above.

6. The supported catalyst system of paragraph 1, wherein the second catalyst is 2-dimethylamino-N,N-bis [methylene(4-methyl-2-(9-methyl-9H-fluoren-9-yl)phenolate)]ethanamine zirconium(IV) dibenzyl and/or 2-dimethylamino-N,N-bis[methylene(4-methyl-2-(9-methyl-9H-fluoren-9-yl)phenolate)]ethanamine hafnium(IV) dibenzyl, and the first catalyst is 2,6-Bis[1-(2-chloro-4,6-dimethylphenylimino)ethyl]pyridine iron(II) dichloride.
7. The supported catalyst system of any of the above paragraphs 1-6 wherein, the support comprises silica, alumina, silica-alumina, and combinations thereof.
8. The supported catalyst system of any of the above paragraphs 1-7, wherein the support material has a surface area of 10 m²/g to 700 m²/g and an average particle diameter of 10 μm to 500 μm.
9. The supported catalyst system of paragraph 1, wherein the support material comprises silica and has a surface area of 10 m²/g to 700 m²/g and an average particle diameter of 10 μm to 500 μm.
10. The supported catalyst system of any of paragraphs 1 to 9, wherein the support material is fluorided.
11. The supported catalyst system of any of paragraphs 1 to 9, wherein the support material is fluorided and has a fluorine concentration in the range of 0.6 wt % to 3.5 wt %, based upon the weight of the support material.
12. The supported catalyst system of any of paragraphs 1 to 11, wherein the activator comprises alumoxane.
13. The supported catalyst system of any of paragraphs 1 to 12, wherein the activator comprises non-coordinating anion.
14. The supported catalyst system of any of paragraphs 1 to 12, wherein the activator, wherein the activator comprises one or more of: methylalumoxane, N,N-dimethylanilinium tetrakis(perfluoronaphthyl)borate, N,N-dimethylanilinium tetrakis(perfluorobiphenyl)borate, N,N-dimethylanilinium tetrakis(perfluorophenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl) pyrrolidinium; N,N-dimethylanilinium tetrakis(pentafluorophenyl)borate, and 4-(tris(pentafluorophenyl)borate)-2,3,5,6-tetrafluoropyridine.
15. A process for polymerization of olefin monomers comprising contacting one or more monomers with the supported catalyst system of the supported catalyst system of any of paragraphs 1 to 14.
16. The process of paragraph 15, wherein the first catalyst component and the second catalyst component show different hydrogen responses.
17. The process of paragraph 15 or 16, wherein the monomer(s) are selected from the group consisting of C₂ to C₄₀ olefins.
18. The process of paragraph 17, wherein the monomer(s) are selected from the group consisting of ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof.
19. The process of paragraph 17, wherein the monomer(s) are selected from the group consisting of ethylene, propylene, 1-hexene, 1-octene and combinations thereof.
20. The process of any of paragraphs 15 to 19, wherein the polymerization is carried out in slurry phase.
21. The process of any of paragraphs 15 to 20, wherein the polymerization is carried out in gas phase.
22. The process of any of paragraphs 15 to 21, wherein the process is a continuous process.
23. The process of any of paragraphs 15 to 22, further comprising obtaining a polyolefin having a multi-modal molecular weight distribution.
24. The process of any of paragraphs 15 to 23, further comprising obtaining a polyolefin having a T75-T25, as measured by TREF, that is greater than 20° C.

### EXPERIMENTAL

The foregoing discussion can be further described with reference to the following non-limiting examples.

### Example 1

### Catalyst Synthesis:

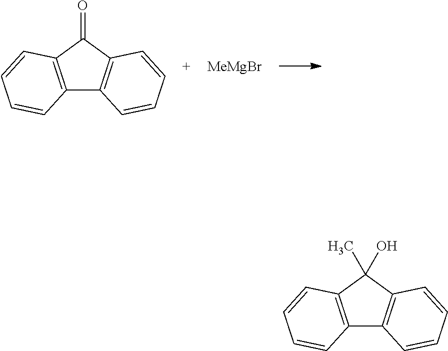

Synthesis of 9-methyl-9H-fluoren-9-ol (S1). In a glovebox, a 250 mL round-bottom flask was charged with 9H-fluoren-9-one (10.300 g, 57.2 mmol, 1.0 eq) and tetrahydrofuran (80 mL), and the resulting solution was cooled to 0° C. MeMgBr (20.0 mL of a 3.0 M solution, 0.6 mmol, 1.05 eq) was then slowly added using a syringe to the stirring solution, which turned into a slurry at the end of the addition. The mixture was warmed to room temperature and allowed to stir for 16 hours. The reaction vessel was then removed from the glovebox, and the reaction mixture was poured into a saturated solution of NH₄Cl(200 mL) and washed with brine (100 mL×2). The organic portion was collected, dried over MgSO₄, filtered and concentrated under a nitrogen stream. The crude product was recrystallized in pentane (200 mL) yielding S1 (10.077 g, 90%) as a white powder.

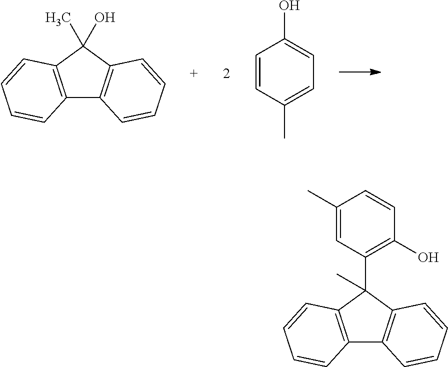

Synthesis of 4-methyl-2-(9-methyl-9H-fluoren-9-yl)phenol (S2). In a 500 mL round-bottom flask, p-cresol (7.8 g, 72 mmol, 2 eq) was dissolved in 200 mL of dichloromethane (DCM) followed by slow addition of concentrated sulfuric acid (3.916 g, 37.93 mmol, 1 eq). A solution of S1 (7.403 g, 37.72 mmol, 1 eq) in DCM (150 mL) was then added to the flask using an addition funnel, and the resulting yellow solution was stirred for 3 hours at room temperature during which the color turned green. The reaction was basified with 2M NaOH to pH 9-10. The organic layer was collected, washed with brine, dried with MgSO₄ and concentrated under a nitrogen stream. The crude product was purified over a Biotage silica column using a gradient of 5-20% DCM in hexane, which yielded S2 (8.437 g, 78%) as a white crystalline powder.

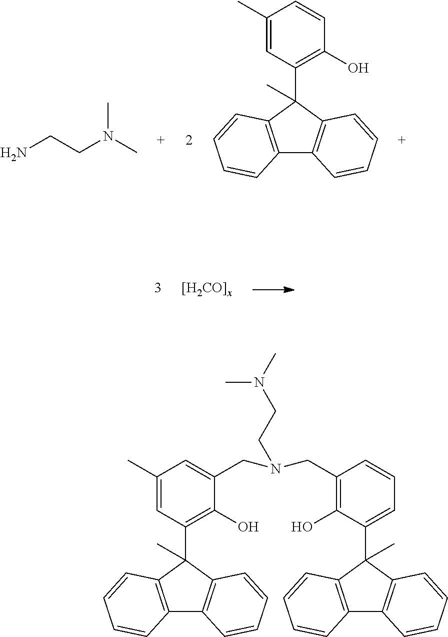

Synthesis of 2-(((2-(dimethylamino)ethyl)(2-hydroxy-3-(9-methyl-9H-fluoren-9-yl)benzyl)amino)methyl)-4-methyl-6-(9-methyl-9H-fluoren-9-yl)phenol (L5). A 50 mL round-bottom flask was charged with S2 (0.755 g, 2.64 mmol, 2 eq), paraformaldehyde (0.109 g, 3.63 mmol, 3 eq), LiCl (0.122 g, 2.88 mmol, 2 eq), 2-dimethylaminoethanamine (0.117 g, 1.33 mmol, 1 eq) and ethanol (4 mL). The resulting white slurry was stirred at 80° C. for 3 days then cooled to room temperature. The supernatant was decanted, and the crude product was purified over silica gel, eluting with a gradient of 0-20% ethyl acetate in hexane, to give L5 (0.696 g, 77%) as a white powder.

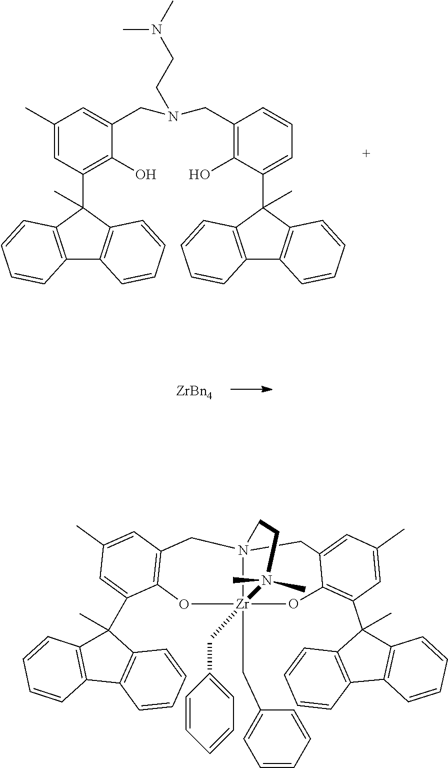

Synthesis of 2-dimethylamino-N,N-bis[methylene(4-methyl-2-(9-methyl-9H-fluoren-9-yl)phenolate)]ethanamine zirconium(IV) dibenzyl (5-Zr). In a glovebox, a 20 mL vial was charged with L5 (0.1708 g, 0.2494 mmol, 1 eq), ZrBn₄ (0.1130 g, 0.2480 mmol, 1 eq), and 3 mL toluene. The resulting orange solution was stirred at 60° C. for 3 hours then cooled to room temperature. The volatiles were removed from the mixture under nitrogen flow, and the resulting residue was recrystallized in 2 mL pentane at −35° C. Removal of the supernatant followed by drying under reduced pressure yielded 5-Zr (0.2304 g, 97%) as a pale yellow powder. ¹H NMR (400 MHz, CD₂Cl₂)— broad and overlapping resonances; S=8.37, 7.77, 7.42, 7.32, 7.24, 7.18, 6.81, 6.65, 6.55, 3.13, 2.73, 2.38, 1.91.

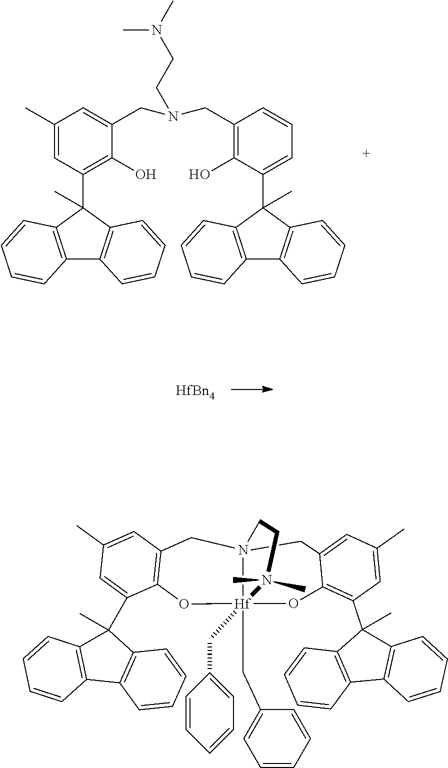

Synthesis of 2-dimethylamino-N,N-bis[methylene(4-methyl-2-(9-methyl-9H-fluoren-9-yl)phenolate)]ethanamine hafnium(IV) dibenzyl (5-Hf). In a glovebox, a 20 mL vial was charged with L5 (0.1867 g, 0.2726 mmol, 1 eq), HfBn₄ (0.1508 g, 0.2777 mmol, 1 eq), and 3 mL toluene. The resulting yellow solution was stirred at 60° C. for 2 hours then cooled to room temperature. The volatiles were removed from the mixture under nitrogen flow, and the resulting residue was recrystallized in 1 mL pentane at −35° C. Removal of the supernatant followed by drying under reduced pressure yielded 5-Hf (0.2756 g, 92%) as a very light tan powder. ¹H NMR (400 MHz, CD₂Cl₂)— broad and overlapping resonances; S=8.31, 7.81, 7.43, 7.32, 7.24, 7.22, 7.18, 7.16, 6.85, 6.83, 6.65, 6.54, 3.25, 3.09, 2.78, 3.42, 2.23, 2.08, 1.86, 1.73, 1.49.

Synthesis of 2,6-bis-[1-(2-chloro-4,6-dimethylphenylimino)ethyl]pyridine. Solid 2,6-diacetylpyridine (5.0 g, 31 mmol) was dissolved in methanol (100 mL). Then, a solid 2-chloro-4, 6-dimethyl aniline (9.537 g, 62 mmol) and formic acid (0.5 mL) were added. The resulting mixture was stirred at room temperature for 48 hours, and a colorless solid precipitated out during the course of reaction. Colorless crystalline solids were filtered out and washed with cold methanol. Crude materials ¹H NMR spectrum showed that there is a 1:1 ratio of title precursor compound and starting material 2-chloro-4,6-dimethyl aniline. The desired compound was purified by column chromatography with a mixture of hexane/ethyl acetate (8:2 ratio) as eluent and solvent removal resulted in colorless crystalline solid (2,6-bis-[1-(2-chloro-4,6-dimethylphenylimino)ethyl]pyridine) in 2.5 g (18.6%) yield. ¹H NMR (400 MHz, CD₂C₂): δ 2.06 (6H, s, CH₃ side arms), 2.29 (6H, s, CH₃), 2.31 (6H, s, CH₃), 6.99 (2H, s, Ar—CH), 7.11 (2H, s, Ar—CH), 7.95 (1H, t, Ar—CH), 8.47 (2H, d, Ar—CH) ppm.

Synthesis of 2,6-bis-[1-(2-chloro-4,6-dimethylphenylimino)ethyl]pyridine iron dichloride. A solid pro-ligand, 2,6-Bis-[1-(2-chloro-4,6-dimethylphenylimino)ethyl]pyridine, was dissolved in THF (40 mL) and cooled to −25° C., to this a solid pre-dried iron chloride was added. The resulting mixture was stirred overnight at room temperature. The resulting mixture color turned from brown to blue during the course of the reaction and the desired iron complex was precipitated out as blue solids. The blue iron compound was filtered out and washed with hexane. The crude materials were further re-dissolved in dichloromethane to remove any insoluble iron containing impurities and ionic compounds formed during the course of the reaction, which could not be identified by ¹H NMR measurements because of their faster relaxation rate (paramagnetic nature) on NMR timescale. Solvent removal under reduced pressure resulted in blue crystalline solid of the 2,6-bis-[1-(2-chloro-4,6-dimethylphenylimino)ethyl]pyridine iron dichloride in 1.89 g (81.9%) yield. ¹H NMR (400 MHz, CD₂Cl₂): δ−23.2, −21.0, 3.7, 9.1, 12.2, 15.3, 18.4, 19.3, 22.0, 22.2, 32.9, 33.9, 81.9, 84.2 (bs) ppm.

### Dual Catalyst Synthesis:

ES-70-875 silica is ES70™ silica (PQ Corporation, Conshohocken, Pa.) that has been calcined at approx. 875° C. Typically, the ES70™ silica is calcined at 880° C. for four hours after being ramped to 880° C. according to the following ramp rates:

| ° C. | ° C./h | ° C. |
|---|---|---|
| ambient | 100 | 200 |
| 200 | 50 | 300 |
| 300 | 133 | 400 |
| 400 | 200 | 800 |
| 800 | 50 | 880 |

SMAO-ES70-875: Methylalumoxane treated silica was prepared in a manner similar to the following: In a 4 L stirred vessel in a drybox methylalumoxane (MAO, 30 wt % in toluene, approx. 1,000 grams) is added along with approx. 2,000 g of toluene. This solution is then stirred at 60 RPM for 5 minutes. Next, approx. 800 grams of ES-70-875 silica is added to the vessel. This slurry is then heated at 100° C. and stirred at 120 RPM for 3 hours. The temperature is then reduced to 25° C. and cooled to temperature over 2 hours. Once cooled, the vessel is set to 8 RPM and placed under vacuum for 72 hours. After emptying the vessel and sieving the supported MAO, approximately 1,100 g of supported MAO will be collected.

Catalyst 1: 2-dimethylamino-N,N-bis[methylene(4-methyl-2-(9-methyl-9H-fluoren-9-yl)phenolate)]ethanamine zirconium(IV) dibenzyl (0.019 g, 2.0 mmol) and 2,6-Bis[1-(2-chloro-4,6-dimethylphenylimino)ethyl]pyridine iron(II) dichloride (0.011 g, 2.0 mmol) were added to a slurry of 1.0 g of SMAO-ES70-875 in 10 mL toluene in a Celestir vessel. This slurry/mixture was stirred for 3 hours and filtered, washed with toluene (×10 mL) and then hexane (2×10 mL). The supported catalyst was then dried under vacuum for 3 hours.

Catalyst 2: 2-dimethylamino-N,N-bis[methylene(4-methyl-2-(9-methyl-9H-fluoren-9-yl)phenolate)]ethanamine hafnium(IV) dibenzyl (0.013 g, 1.2 mmol) and 2,6-Bis[1-(2-chloro-4,6-dimethylphenylimino)ethyl]pyridine iron(II) dichloride (0.016 g, 2.8 mmol) were added to a slurry of 1.0 g SMAO-ES70-875 in 10 mL toluene in a Celestir vessel. This slurry/mixture was stirred for 3 hours and filtered, washed with toluene (1×10 mL) and then hexane (2×10 mL). The supported catalyst was then dried under vacuum for 3 hours.

### Polymerizations:

A 2 L autoclave was heated to 110° C. and purged with N₂ at least 30 minutes. It was charged with dry NaCl (350 g; Fisher, S271-10 dehydrated at 180° C. and subjected to several pump/purge cycles and finally passed through a 16 mesh screen prior to use) and SMAO-ES70-875 (5 g) at 105° C. and stirred for 30 minutes. The temperature was adjusted to 85° C. At a pressure of 2 psig N₂, dry, degassed 1-hexene (2.0 mL) was added to the reactor with a syringe then the reactor was charged with N₂ to a pressure of 20 psig. A mixture of H₂ and N₂ was flowed into reactor (200 SCCM; 10% H₂ in N₂) while stirring the bed.

Various solid catalysts indicated in Table 1 were injected into the reactor with ethylene at a pressure of 220 psig; ethylene flow was allowed over the course of the run to maintain constant pressure in the reactor. 1-hexene was fed into the reactor as a ratio to ethylene flow (0.1 g/g). Hydrogen was fed to the reactor as a ratio to ethylene flow (0.5 mg/g). The hydrogen and ethylene ratios were measured by on-line GC analysis. Polymerizations were halted after 1 hour by venting the reactor, cooling to room temperature then exposing to air. Salt was removed by washing with water two times. The resulting polymer was isolated by filtration, briefly washed with acetone and dried in air for at least two days.

TABLE 1

| Supported | H2 | | | | | | |
|---|---|---|---|---|---|---|---|
| Catalyst | charge | Yield | Prod. | Mw(IR) | Mn(IR) | | Hexene |
| System | (mls) | (g polyethylene) | (g/g cat) | g/mol | g/mol | Mw/Mn | wt % |
| Catalyst | 0 | 82.6 | 6453 | 366265 | 16236 | 22.56 | 3.10 |
| System 1 | | | | | | | |
| (5-Zr + Fe | | | | | | | |
| catalyst) | | | | | | | |
| 12.8 mgs | | | | | | | |
| Catalyst | 120 | 30.4 | 2375 | 175926 | 14393 | 12.22 | 4.86 |
| System 2 | | | | | | | |
| (5-Hf + Fe | | | | | | | |
| catalyst) | | | | | | | |
| 12 mgs | | | | | | | |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Furthermore, all patents, test procedures, and other documents cited in this specification are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

What is claimed is:

1. A supported catalyst system comprising a first catalyst, a second catalyst, a support material, and an activator; wherein the first catalyst is represented by the Formula (I): 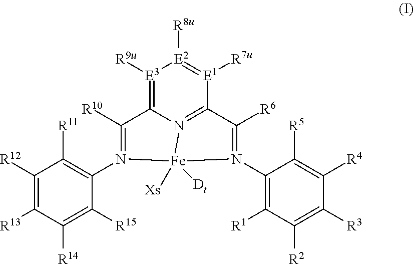
where R¹, R⁵, R¹¹, and R¹⁵ are independently C₁-C₄₀ hydrocarbyl, C₁-C₄₀ substituted hydrocarbyl group, heteroatom or heteroatom-containing group,
R⁷ᵤ, R⁸ᵤ, R⁹ᵤ, R², R³, R⁴, R⁶, R¹⁰, R¹², R¹³, and R¹⁴ are independently hydrogen, C₁-C₄₀ hydrocarbyl, C₁-C₄₀ substituted hydrocarbyl group, heteroatom or heteroatom-containing group, wherein two or more of R⁷ᵤ, R₈^{u}, R⁹ᵤ, R¹, R², R³, R⁴, R⁵, R⁶, R¹⁰, R¹¹, R¹², R¹³, R¹⁴, and R¹⁵, may independently join together to form a C₄ to C₆₂ cyclic or polycyclic ring structure;
E¹, E², and E³ are independently C, N, or P;
each u is independently 0 if E¹, E², and/or E³ is N or P and is 1 if E¹, E², and/or E³ is C;
X is hydrogen, C₁-C₄₀ hydrocarbyl, C₁-C₄₀ substituted hydrocarbyl group, heteroatom or heteroatom-containing group;
s is 1, 2, or 3;
D is a neutral donor; and
t is 0, 1, or 2; and
wherein the second catalyst is represented by the Formula (II): 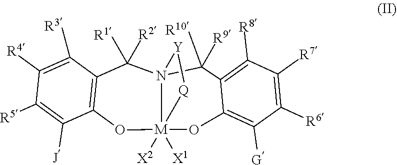
wherein:
M is a group 4 transition metal;
X¹ and X² are independently C₁-C₄₀ hydrocarbyl, C₁-C₄₀ substituted hydrocarbyl, heteroatom or heteroatom-containing group, wherein X¹ optionally bonds with X² to form a C₄ to C₆₂ cyclic or polycyclic ring structure;
R^{1′}, R^{2′}, R^{3′}, R^{4′}, R^{5′}, R^{6′}, R^{7′}, R^{8′}, R^{9′}, and R^{10′} are independently hydrogen, C₁-C₄₀ hydrocarbyl, C₁-C₄₀ substituted hydrocarbyl group, heteroatom or heteroatom-containing group, where two or more of R^{1′} to R^{10′}, J′ and G′ may independently join together to form a C₄ to C₆₂ cyclic or polycyclic ring structure;
J′ is a C₇ to C₆₀ fused polycyclic group, which optionally includes up to 20 atoms from groups 15 and 16, wherein at least one ring can be aromatic and wherein at least one ring, which may or may not be aromatic, has at least five members;
G′ is hydrogen, C₁ to C₆₀ hydrocarbyl, C₁-C₆₀ substituted hydrocarbyl group, a heteroatom or heteroatom-containing group or optionally as defined for J′;
Y is hydrogen, C₁-C₄₀ hydrocarbyl, C₁-C₄₀ substituted hydrocarbyl group, heteroatom or heteroatom-containing group; and
Q is a neutral donor group.

2. The supported catalyst system of claim 1, wherein M is Hf or Zr.

3. The supported catalyst system of claim 1, where in Formula (I), R¹ optionally bonds with R², R² optionally bonds with R³, R³ optionally bonds with R⁴, R⁴ optionally bonds with R⁵, R⁵ optionally bonds with R⁶, R⁶ optionally bonds with R⁷, R⁷ optionally bonds with R, R optionally bonds with R⁹, R⁹ optionally bonds with R¹⁰, R¹⁰ optionally bonds with R¹¹, R¹¹ optionally bonds with R¹², R¹² optionally bonds with R¹³, R¹³ optionally bonds with R¹⁴, and R¹⁴ optionally bonds with R¹⁵, in each case to independently form a five-, six- or seven-membered ring; and
in Formula (II) for example, R^{1′} optionally bonds with R^{2′}, and R^{2′} optionally bonds with R^{3′}, R^{3′} optionally bonds with R^{4′}, R^{4′} optionally bonds with R^{5′}, R^{5′} optionally bonds with J′, G′ optionally bonds with R^{6′}, R^{6′} optionally bonds with R^{7′}, R^{7′} optionally bonds with R′, R′ optionally bonds with R^{9′}, R^{9′} optionally bonds with R^{10′} in each case to independently form a five-, six- or seven-membered ring.

4. The supported catalyst system of claim 1, wherein the first catalyst is one or more of:
bis(2,6-[1-(2,6-dimethylphenylimino)ethyl])pyridineiron dichloride,
bis(2,6-[1-(2,4,6-trimethylphenylimino)ethyl)])pyridineiron dichloride,
bis(2,6-[1-(2,6-dimethylphenylimino)ethyl]-ethyl])pyridineiron dichloride,
2-[1-(2,4,6-trimethylphenylimino)ethyl]-6-[1-(2,4-dichloro-6-methylphenylimino)ethyl]pyridineiron dichloride,
2-[1-(2,6-dimethylphenylimino)ethyl]-6-[1-(2-chloro-6-methylphenylimino)ethyl]pyridineiron dichloride,
2-[1-(2,4,6-trimethylphenylimino)ethyl]-6-[1-(2-chloro-6-methylphenylimino)ethyl]pyridineiron dichloride,
2-[1-(2,6-diisopropylphenylimino)ethyl]-6-[1-(2-chloro-6-methylphenylimino)ethyl]pyridineiron dichloride,
2-[1-(2,6-dimethylphenylimino)ethyl]-6-[1-(2-bromo-4,6-dimethylphenylimino)ethyl]pyridineiron dichloride,
2-[1-(2,4,6-trimethylphenylimino)ethyl]-6-[1-(2-bromo-4,6-dimethylphenylimino)ethyl]pyridineiron dichloride,
2-[1-(2,6-dimethylphenylimino)ethyl]-6-[1-(2-bromo-6-methylphenylimino)ethyl]pyridineiron dichloride,
2-[-(2,4,6-trimethylphenylimino)ethyl]-6-[1-(2-bromo-6-methylphenylimino)ethyl]pyridineiron dichloride, and
2-[1-(2,6-diisopropylphenylimino)ethyl]-6-[-(2-bromo-6-methylphenylimino)ethyl]pyridineiron dichloride, or the dibromides or tribromides thereof.

5. The supported catalyst system of claim 1 wherein, the second catalyst is represented Formulas (V) or (VI): 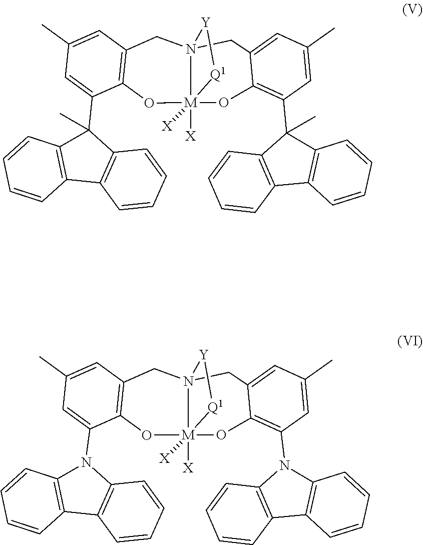
wherein:
Y is a C₁-C₃ divalent hydrocarbyl, Q¹ is NR′₂, OR′, SR′, PR′₂, where R′ is hydrogen, C₁-C₄₀ hydrocarbyl, C₁-C₄₀ substituted hydrocarbyl group, heteroatom or heteroatom-containing group, alternately the —(-Q¹-Y—)— fragment can form a substituted or unsubstituted heterocycle, which may or may not be aromatic, and may have multiple fused rings, M is Zr, Hf, or Ti and each X is, independently, as defined for X above.

6. The supported catalyst system of claim 1 wherein, the second catalyst is 2-dimethylamino-N,N-bis [methylene(4-methyl-2-(9-methyl-9H-fluoren-9-yl)phenolate)]ethanamine zirconium(IV) dibenzyl and/or 2-dimethylamino-N,N-bis[methylene(4-methyl-2-(9-methyl-9H-fluoren-9-yl)phenolate)]ethanamine hafnium(IV) dibenzyl, and the first catalyst is 2,6-Bis[1-(2-chloro-4,6-dimethylphenylimino)ethyl]pyridine iron(II) dichloride.

7. The supported catalyst system of claim 1 wherein, the support comprises silica.

8. The supported catalyst system of claim 1, wherein the support material has a surface area of 10 m²/g to 700 m²/g and an average particle diameter of 10 μm to 500 μm.

9. The supported catalyst system of claim 1, wherein the support material comprises silica, alumina, silica-alumina, and combinations thereof.

10. The supported catalyst system of claim 1, wherein the support material is fluorided.

11. The supported catalyst system of claim 1, wherein the support material is fluorided and has a fluorine concentration in the range of 0.6 wt % to 3.5 wt %, based upon the weight of the support material.

12. The supported catalyst system of claim 1, wherein the activator comprises alumoxane.

13. The supported catalyst system of claim 1, wherein the activator comprises a non-coordinating anion.

14. The supported catalyst system of claim 1, wherein the activator, wherein the activator comprises one or more of: methylalumoxane, N,N-dimethylanilinium tetrakis(perfluoronaphthyl)borate, N,N-dimethylanilinium tetrakis(perfluorobiphenyl)borate, N,N-dimethylaniliniumtetrakis(perfluorophenyl)borate, N,N-dimethylaniliniumtetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, triphenylcarbenium tetrakis(perfluorophenyl)borate, [Me₃NH⁺][B(C₆F₅)₄⁻]; 1-(4-(tris(pentafluorophenyl)borate)-2,3,5,6-tetrafluorophenyl) pyrrolidinium; N,N-dimethylanilinium tetrakis(pentafluorophenyl)borate, and 4-(tris(pentafluorophenyl)borate)-2,3,5,6-tetrafluoropyridine.

15. A process for polymerization of olefin monomers comprising contacting one or more monomers with the supported catalyst system of claim 1.

16. The process of claim 1, wherein the first catalyst component and the second catalyst component show different hydrogen responses.

17. The process of claim 15, wherein the monomer(s) are selected from the group consisting of C₂ to C₄₀ olefins.

18. The process of claim 15, wherein the monomer(s) are selected from the group consisting of ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof.

19. The process of claim 15, wherein the monomer(s) are selected from the group consisting of ethylene, propylene, 1-hexene, 1-octene and combinations thereof.

20. The process of claim 15, wherein the polymerization is carried out in slurry phase.

21. The process of claim 15, wherein the polymerization is carried out in gas phase.

22. The process of claim 15, wherein the process is a continuous process.

23. The process of claim 15, further comprising obtaining a polyolefin having a multi-modal molecular weight distribution.

24. The process of claim 15, further comprising obtaining a polyolefin having a T₇₅-T₂₅, as measured by TREF, that is greater than 20° C.
